(19) United States
(12) Patent Application Publication
(10) Pub. No.: US 2008/0174676 A1
(43) Pub. Date: Jul. 24, 2008

(54) PRODUCING ENHANCED PHOTOGRAPHIC PRODUCTS FROM IMAGES CAPTURED AT KNOWN EVENTS

(76) Inventors: John R. Squilla, Rochester, NY (US); John R. Fredlund, Rochester, NY (US); Joseph A. Manico, Rochester, NY (US)

Correspondence Address: Frank Pincelli;Patent Legal Staff, Eastman Kodak Company, 343 State Street, Rochester, NY, 14650-2201, US

(21) Appl. No.: 11/626,471

(22) Filed: Jan. 24, 2007

(51) Int. Cl. H04N 5/76

(52) U.S. Cl. 348/231.6

(57) ABSTRACT

A photographic system for producing an enhanced photographic product is provided. The system includes a database for storing custom content for a plurality of events. The system also includes a digital image capture device that stores a digital image and information defining the date/time and geographic location of the digital image. A Service Provider automatically determines if the timestamp and the geographic information corresponds to events stored in the custom content database. A processor produces an enhanced photographic product including the captured digital image and custom content corresponding to the timestamp and location of the captured digital image.

### CROSS REFERENCE TO RELATED APPLICATIONS

Reference is made to commonly assigned U.S. patent application Ser. No. 10/392,994, filed Mar. 20, 2003, entitled “Producing Enhanced Photographic Products From Images Captured At Known Sites,” by John R. Squilla; John R. Fredlund; and Joseph A. Manico; the disclosure of which is incorporated herein.

### FIELD OF THE INVENTION

The invention relates generally to the field of photography, and in particular to a photographic system that is capable of acquiring digital data associated with the content of photos captured at known times and locations. More specifically, the invention relates to a method utilizing the acquired data for marketing and producing enhanced photographic products from images captured at such sites.

### BACKGROUND OF THE INVENTION

When pictures are taken by a photographer, e.g., especially an amateur or consumer photographer, using a traditional (film) or digital camera while visiting a known (or otherwise designated) picture site, such as a predetermined picturesque location at a theme park or at a National Park, it is desirable to identify and automatically enhance the images in order to produce a keepsake of the visit (album, interactive CD, DVD, etc.). The key enablers are: knowing the location of the picture sites where the consumer has captured the images, and having content information (e.g., audio, graphics, visual and/or textual descriptive content information, or the like) about the site.

It is known in the art that a traditional (film), electronic, or video camera can either record image information on a photographic film or store the information in electronic memory. It is also known in the art that a wireless transceiver can be used to transmit and receive data in low-power, portable environments, such as would be encountered in connection with the aforementioned picture sites. An example of such a device is shown in U.S. Pat. No. 4,957,348, which describes a low-power optical transceiver including an IR transmitter-receiver. Digital cameras also have the capability of storing additional information along with the image. An example of a digital camera with such capability is the Kodak DCS 460 Digital Camera, which is capable of storing voice annotation and Global Positioning System (GPS) parameters along with the digital image. Moreover, Advanced Photo System™ cameras, which are sold by Eastman Kodak Company and others, use a photographic film referred to as Advantix™ film, which allows the camera to store digital information on a clear magnetic layer on the back of the film. This feature is disclosed in commonly-assigned U.S. Pat. No. 5,194,892, which also describes an information exchange system for users of such film, such as a camera user and a photofinisher.

In U.S. Pat. No. 5,296,884, a still video or a film camera can receive location coordinates, such as GPS signals, from a wireless source, and then convert that information to a location name such as a name of a city. The city name is then stored with the video image or recorded on the film. In addition to place names, the patent alludes to the possibility of storing various data relating to place, such as origins of city names and special products of the region. Moreover, a local transmitting station may be installed which transmits codes relating to place directly to the camera, e.g., in tourist areas or facilities. In U.S. Pat. No. 5,479,228, a camera system includes a memory that can store a set of optional phrases such as “Happy New Year” and “Happy Birthday”, which then can be stored on the magnetic layer of Advantix™ film and printed on a photograph during a subsequent processing operation.

Commonly assigned U.S. Pat. No. 5,768,633 discloses a photographic and data transmission system especially for use at a tradeshow. A wireless communication system is installed at a booth in a tradeshow for transmitting wireless information related to a product on display, such as the product name, company name, price and the Uniform Resource Locator (URL) address of the product source on the Internet. The other part of the system is a camera capable of receiving the wireless transmission. When the camera is brought into the vicinity of the booth and captures an image of the product, a trigger signal from the camera initiates transmission of the wireless signal from the tradeshow booth. The camera then stores the product data with the image or stores a URL address that can direct the user to more information via the Internet.

EP Patent Specification No. EP0 640 938 B1 describes a personalized image recording system intended to create still images or video collections for guests of amusement parks. Each guest is associated with a unique identifier in the form of a readable tag worn by the guest. When the tag is brought into the vicinity of an attraction, the tag triggers a camera located at the attraction to capture an image, e.g., of the guest. A communications network interconnects the cameras and tag readers with a central control system that creates collections of images, including the captured images and other prerecorded stock footage. The control system arranges the images, according to preferences of the guest, into collections that capture the experience of visiting the amusement park.

In commonly assigned U.S. Pat. No. 6,396,537, a photographic system utilizes data associated with a scene location, e.g., a visitor attraction site, that is capable of interactive communication with a user. The attraction site stores content data related to the site, and the user communicates with the attraction site through a camera that is enabled for such communication. Besides capturing an image associated with the site, the camera stores predetermined personality data that relates an interest of the user to the content data and includes means for transferring the personality data to the attraction site. The camera further includes means for receiving and displaying the portion of the content data from the attraction site that is relevant to the user's preferences, and a user interface for selecting from the displayed content data that part which the user wants to keep. In this manner, information relevant to a user's interests about a photographed item can be easily requested, accessed and stored with the specific pictures that the user has captured.

In U.S. Pat. No. 6,337,951, a data sender is installed in a designated place, like a particular animal cage at a zoo, where the probability of photography is high. The data sender sends out photo data, such as a place ID, relating to the designated place. A receiver for receiving photo data from the data sender and a data storage device for storing the photo data are incorporated into a camera. The photo data is then written into the data storage device in association with an image captured by the camera at the designated place. The photo data is later retrieved from the camera and used to access data corresponding to the scene, such as the name and history of the photo subject. The scene data may be used in an electronic album, an image data base, or as print data.

Consequently, if a person takes a picture at a known location and there has been content collected about that site, the combination of knowing where and when the picture has been taken and the collected content information can allow the enhancement of both the image and the way it is presented. In particular, digital images, captured by either a digital camera or digitized from images captured on film, can thus be used to create multimedia files. These files combine still images and other types of data such as text, graphics, audio and video. Gathering the extra digital information needed for creating a multimedia file is a time-consuming process. The Internet and World Wide Web has made that process easier, but much of the content useful for the multimedia files is copyrighted and not readily available on the Internet sites. Moreover, the user needs a multimedia computer to put the information together. The user also needs to locate the URL addresses of these information sites.

The drawback with the present systems is the information overload and the processing required, that is, the volume of information can overwhelm the casual user who is trying to assemble a record associated with a particular event, e.g., say a visit to a theme park or a site in the National Park system. Moreover, the processing involved in creating an enhanced photo product can challenge the capability (as well as the time and interest) of the ordinary consumer. It would be desirable to find a convenient way to combine the information handling capability of modern cameras with image recording so that information relevant to a user's interests can be easily requested and accessed about a photographed item. This would then lead to an enhanced photo product with minimal impact upon the consumer.

Moreover, mobile camera phones are used by a growing number of consumers to capture and transmit digital images. Some mobile phone cameras, such as the Motorola i855, include a GPS receiver that can determine the location of the camera phone when a particular digital image is captured. The captured digital images and GPS coordinates can be uploaded to an Internet site, such as www.trimbleoutdoors.com. This site enables a user to view a map of an area, and to see thumbnail images of the digital images that have been uploaded.

Some PDA devices enable a user to view location-specific information as the user travels. For example, they can selectively view the locations and menus of nearby restaurants, in order to decide where to eat lunch.

Some software programs, such as Kodak Easyshare Gallery Collage software, enable a user to combine digital images that they have captured with other photographs, such as stock photos of different events. This enables the user to produce a photo product, such as a collage, which includes both their own images and other images of a certain event.

For example, if a family attends the Rose Bowl Parade, they might be inclined to have an enhanced photo product, such as framed montage print that includes images of the family captured using their own digital camera, as well as professional images of the parade captured from other vantage points, such as an overhead camera. The resulting photo products, which combine a users images with high quality content from other sources, are very attractive. Unfortunately, producing such photo products takes significant time and skill, as well as the ability to access copyrighted professional content of the event. Therefore, these types of photo products are rarely created by users.

What is needed is a more automatic method of creating photo products which combine both a user's images and a high quality content from the same event depicted in the user captured images.

### SUMMARY OF THE INVENTION

The present invention is directed to overcoming one or more of the problems set forth above. Briefly summarized, according to one aspect of the present invention, a method for producing an enhanced photographic product, including storing custom content for a plurality of events in a custom content database, receiving a digital image and information from a digital image capture device defining the time and geographic location the digital image was captured, automatically determining if the time and the geographic information corresponds to one or more of the plurality of events stored in the custom content database, and producing an enhanced photographic product including the received digital image and at least a portion of the custom content for one or more plurality of events in the custom content database corresponding to the digital image.

In another embodiment a method for producing an enhanced photographic product is provided. The method includes storing custom content for a plurality of events in a custom content database, automatically determining if user time and geographic information corresponds to one of the plurality of events in the custom content database, prompting the user to capture images when the user geographic information corresponds to at least one of the plurality of events, capturing a digital image using a digital device of the user and receiving geographic information and user time defining the location of the user and the time when the digital image was captured, and producing an enhanced photographic product comprising the received digital image and at least a portion of the custom content.

In yet another embodiment a system for producing an enhanced photographic product is provided. The system includes a database for storing custom content for a plurality of events, a digital image capture device for receiving a digital image and information defining the time and geographic location the digital image was captured and automatically determining if the time and the geographic information corresponds to one or more of the plurality of events stored in the database, and a processor for producing an enhanced photographic product including the received digital image and at least a portion of the custom content corresponding to the digital image for the one or more plurality of events found in the database.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a combined pictorial and block diagram of a photographic system for producing enhanced photographic products from images captured at known picture sites in accordance with the invention.

FIG. 2 is a block diagram of a digital camera used in the photographic system shown in FIG. 1.

FIG. 3 is a block diagram of a film camera used in the photographic system shown in FIG. 1.

FIG. 4 is a flow diagram of a method for creating, and adding to, a content database.

FIG. 5 is a flow diagram of a method, including on-line registration, for customer interface with the system and method according to the invention.

FIG. 6 is a flow diagram of a method, including on-site registration, for customer interface with the system and method according to the invention.

FIG. 7 is a flow diagram of a method for generating an enhanced photographic product from a currently captured image and a reference (stock) image.

FIG. 8 is an example of an enhanced photographic product prepared according to the method of FIG. 7 for a currently captured photo and a historically related stock image (then and now photos).

FIG. 9 is a flow diagram of a method for generating an album from customer photos.

FIG. 10 is a flow diagram of a method for generating a CD or DVD from customer photos.

FIGS. 11A and 11B show a flow diagram and a product example of a method for generating an adhesive sticker printed with content data, that attaches to the back of a print.

FIGS. 12A, 12B and 12C are pictorial diagrams of a data collection system that attaches to a traditional (film) or digital camera for collecting meta data associated with picture sites.

FIG. 13 is a flow diagram of a method for using the system shown in FIG. 12.

FIG. 14 is a pictorial diagram showing use of the attachment shown in FIG. 12A with a single use camera.

FIG. 15 is a flow diagram illustrating an image removal option for images recorded on a CD or DVD generated according to flow diagram in FIG. 10.

FIG. 16 is a combined pictorial and block diagram of an additional embodiment for producing enhanced photographic products from images captured at known picture sites in accordance with the invention, wherein the collection of location data is separate from image data.

FIG. 17 is a block diagram of a digital photography system which captures and utilizes digital images and location information.

FIG. 18 is a block diagram of a camera phone used in the digital photography system of FIG. 17.

FIG. 19 is a flow diagram showing a first embodiment of the present invention.

FIG. 20 depicts a photo product produced using the method of FIG. 19.

FIG. 21 is a flow diagram showing a second embodiment of the present invention.

FIG. 22 depicts a photo product produced using the method of FIG. 21.

FIG. 23 depicts a photo product template that may be used to prompt a user to take pictures when at a specific location or event

### DETAILED DESCRIPTION OF THE INVENTION

Because photographic systems employing data collection relating to specific sites are well known, the present description will be directed in particular to elements forming part of, or cooperating more directly with, system and method in accordance with the present invention. Elements not specifically shown or described herein may be selected from those known in the art. Certain aspects of the embodiments to be described may be provided in software. Given the system and method as shown and described according to the invention in the following materials, software not specifically shown, described or suggested herein that is useful for implementation of the invention is conventional and within the ordinary skill in such arts.

Still further, as used herein, the computer program may be stored in a computer readable storage medium, which may comprise, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program.

There are locations, referred to herein as picture sites or attraction sites, that inspire people due to their natural beauty, uniqueness or historical significance. Often this inspiration includes taking a photo at that location. The specifics of that location's significance are often noted in some sort of signage or kiosk. People sometimes take a picture of the sign to help them remember these details. However, much of the information about the site is lost (or simply never known because much of the detail is not shown and/or rarely updated).

Furthermore, there are large events that take place at a specific location (which can be, for example, a sports stadium or a public park) during a specific time period. Examples of particular events include Super Bowl XL held on Feb. 5, 2006 at Ford Stadium in Detroit, the 2006 Rose Bowl parade held Jan. 1, 2006 along a known route in Pasadena, Calif., and the 2006 Lilac Festival held at Highland Park in Rochester, N.Y. on May 12-26, 2006.

The present invention defines techniques for automatically determining whether the images captured using a digital capture device (such as a camera phone) were taken during a particular event. This is done by capturing digital images, location, and time information in the digital capture device, storing each image and the corresponding location and time information in an image file, and transferring the image files to a service provider. The location information can be provided using a Geographical Information Services (GIS) location receiver, such as a Global Positioning System (GPS) receiver. The service provider compares the location and time information of the transferred user images with a database of information defining locations and events, to determine if it corresponds to a location or event that is supported by professional content in a database at the service provider.

If the service provider determines that the user's photos correspond to a supported location or event, the service provider can automatically create an offer to the user for a customized photo product, which includes both the user's content and appropriate professional content for the location or event. The user can then select the product, further modify the photos included in the product, and place an order for the customized photo product. As an example, if the service provider determines that the images were taken in Minute Maid Park Stadium in Houston during the evening of Oct. 26, 2005, the customized photo product can be a framed poster print featuring the White Sox victory in the World Series. The poster print can include some of the user's favorite images taken at the stadium, as well as professional photos of stadium and the key plays. The poster print can also include an event-specific background, and text saying for example “White Sox win the World Series in four games, defeating the Astros 1 to 0 in the final game on Oct. 26, 2005”.

The invention described herein further discloses a methodology and a system for automatically capturing necessary information at these events and then allowing for this information to drive additional media (movies, pictures, sounds and the like) which can be automatically placed into a digital review of the trip/occasion, or enhance albums or even individual photos. The information can also be utilized by individuals to personally enhance their memories (scrapbooks, web sites, traditional albums, etc.).

The embodiments shown herein utilize various techniques for gathering information related to the sites. One technique is based on using the Global Positioning System (GPS), perhaps together with an electronic compass, to collect location information. Radio frequency (RF), infra red (IR) and image identification methodologies can also be used to gather location information.

Using a GPS device, the location of the individual (and, with a compass, the direction toward which the camera is pointing) may be determined at the time of image capture. If a photofinisher has access to this information, for example by means of correlating images to location information on the basis of time of capture, content corresponding to the location can be added to output created for the consumer. Similarly, if RF or IR transmitters are located at the picture site, and the camera or another device in the possession of the consumer is capable of capturing the transmitted data, the location can be determined from this data.

One advantage of an image identification methodology is that it does not require any additional hardware or software in the camera. As mentioned above, however, if image identification is not used, GPS, RF, IR or like technology can provide the additional information needed to perform the tasks required. However, most cameras are not equipped with either of these technologies. Accordingly, the present invention also provides a means to allow standard 35 mm and single use cameras to be equipped with the means necessary to determine the location and to associate it with a particular frame of film.

Even if there is no mechanism to directly determine the location of the captured image, the images captured by the consumer may be submitted to the photofinisher for image analysis and correlation. For instance, the photofinisher or his agent previously captures, or has access to, a professional set of images corresponding to the same picture sites. This professional set is used as the basis of comparison so that the location of capture of the consumer image can be determined. Many aspects of the consumer images may be analyzed for determination of “degree of similarity” to the professional set. One technique of detecting similarity is to use an algorithm that first subtracts the consumer image from the professional image to form a difference image. If the images are similar, a histogram of the difference image will exhibit a large clustering of values around zero. When the algorithm determines that there is a high degree of similarity, the location of capture is considered to match, and additional content can be added to the output, increasing the value of the consumer's images and imaging experience. Alternatively, a trained operator can compare the consumer images with the professional set of images and thereby determine the location of consumer images. A special feature of this approach is that the match can be used to identify a subset of stored content, including images, that pertain to the particular picture site location. This is useful in reducing the amount of content that must be examined and processed.

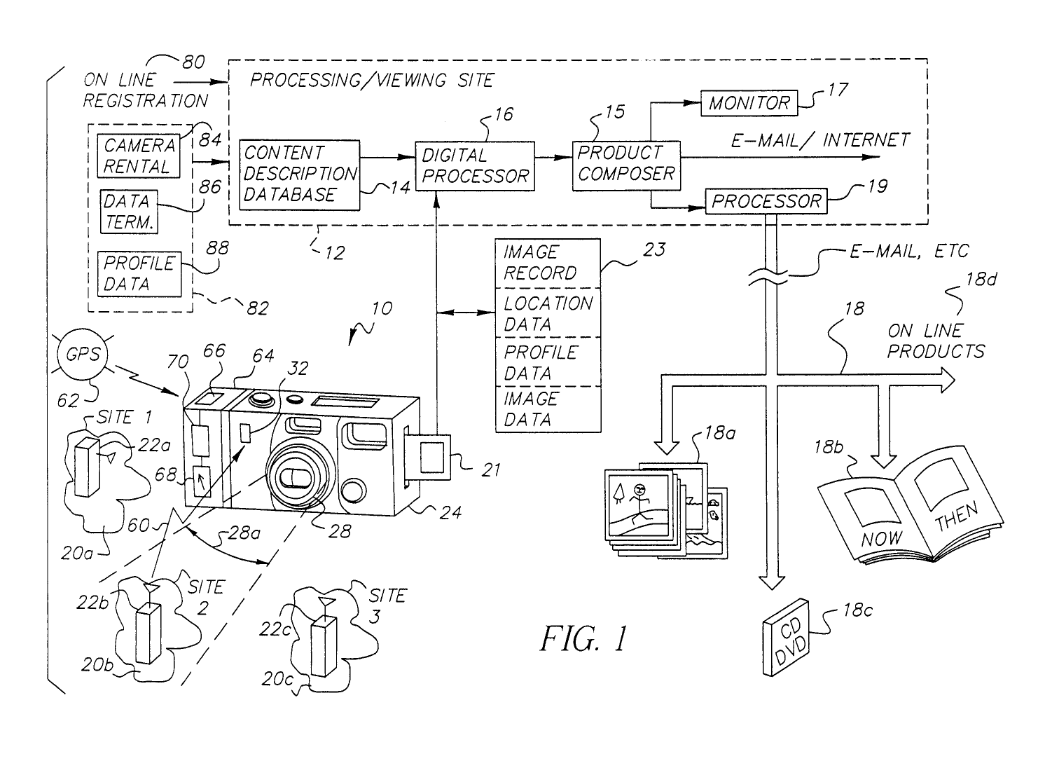

Referring first to FIG. 1, a photographic system is shown for producing enhanced products from pictures captured by a camera capable of additionally capturing location data from which one or more known picture sites may be identified. Each picture site is situated at a predetermined location that represents content of interest to a photographer. The photographic system includes a capture subsystem 10 for capturing images of picture sites and for capturing location data relating the images to the locations of the picture sites, thereby identifying the locations of the images. The photographic system further includes a processing subsystem 12 including a database 14 containing content pertaining to the picture sites and a digital processor 16 using the locations of the images to access selected content in the database 14 pertaining to the picture sites. The processing subsystem 12 then generates enhanced image products 18 from the images by utilizing the selected content pertaining to the picture sites.

The capture subsystem 10 captures images at known picture or attraction sites 20a, 20b and 20c, where a picture is likely to be taken, and additionally where its location data may be determined and obtained. Such attraction sites could be varied and widely spaced, for example including user accessible viewing points within theme parks, amusement parks, sporting sites, National Park system sites, and the like. In one embodiment, each attraction site includes a wireless communication station 22a, 22b and 22c that communicates the location data to the capture subsystem 10. The location data is combined with the image data in a record 23 that is delivered to the digital processor 16 on, e.g., a memory card 21 or wireless transmission. The location data is matched with content description for that location in the content database 14. The digital processor 16 delivers the selected content description to a product composer 15, which may also access product-related choices from a customer/photographer. The product may be applied to a monitor 17 for review by the customer and/or an operator of the processing subsystem 12. For example, the product image on the monitor 17 may function as an electronic proof of an optional final output product, where the user then has input to modify and/or change the image. Given site identification at this stage, a menu of choices for potential changes can be presented to the user appropriate for that particular site. A selected product is applied to a fulfillment processor 19, which produces the enhanced image products 18. These products may take many forms, as will be described, including a package of prints 18a, an album 18b, a CD or DVD 18c, or an on-line product 18d, where each product shows content from the database 14 together with the captured images.

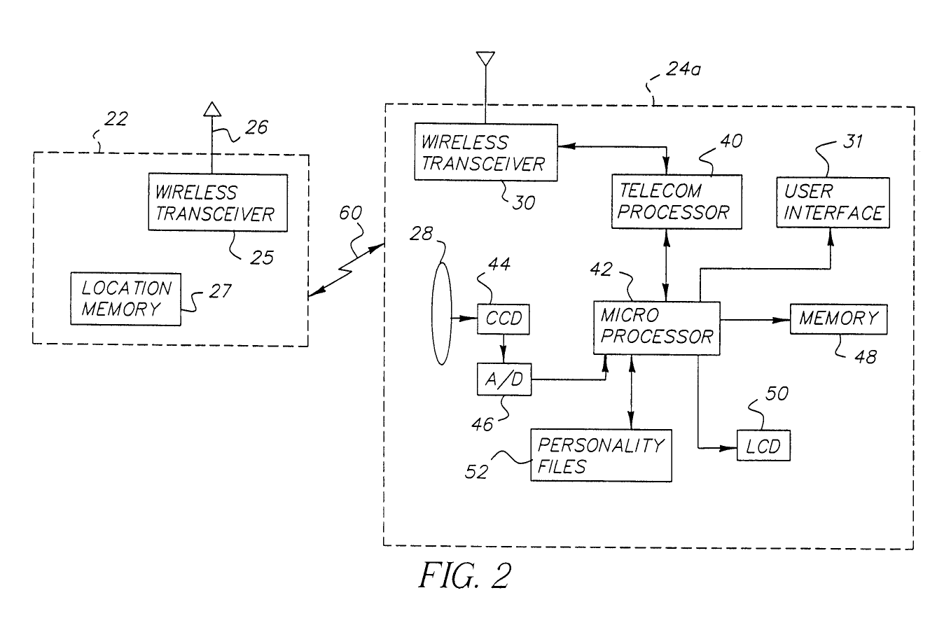

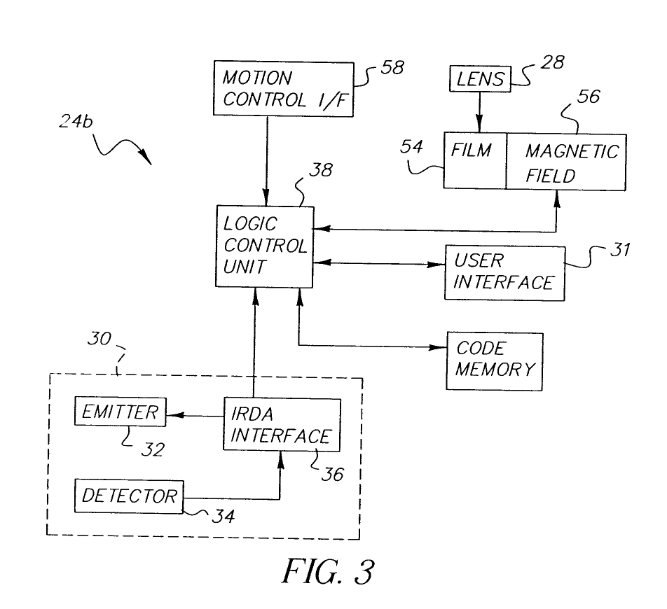

The capture subsystem includes a camera 24. Preferably, the camera 24 is either a digital camera 24a as shown in block diagram in FIG. 2 or an Advantix™ film camera 24b as shown in block diagram in FIG. 3, although other capture devices are included herein without limitation, such as a digital camera incorporated into a cell phone or a personal digital assistant (PDA), or the like. As shown in FIGS. 2 and 3, both types of cameras capture an image of an attraction site through a lens section 28 which, as shown in FIG. 1, would have a field of view 28a including the attraction site. As shown in FIG. 2, the wireless communication station 22 at each attraction site includes a wireless transceiver 25 that interchanges signals with an antenna 26. A location memory 27 provides location data to the wireless transceiver 25. Alternatively, the station can comprise a radio frequency identification (RFID) tag (not shown) that is encoded with data identifying the attraction site. The camera would then include an RFID interrogation unit that would be activated in the vicinity of the RFID tag. Given this transmission capability of the station 22, the attraction site 20 functions as a “communicating scene”, specifically by transmitting a scene location ID to a particular user.

Both cameras 24a and 24b include a transceiver section 30 for communicating with the station 22. Both cameras also include a user interface 31 for communicating user commands to the camera, such as the desire to capture an image, and some type of processing modality, such as a microprocessor 42 or a logic control unit 38. As shown in more detail in one embodiment in FIG. 3, the transceiver section 30 may include an infrared emitter 32 and an infrared detector 34 connected through a conventional IrDA interface 36 to the logic control unit 38. The transceiver section 30 in the digital camera 24a may also include an IR emitter-detector system as shown in FIG. 3; alternatively, both cameras may include other types of transceivers, such as a radio-frequency (RF) transceiver system, or an RFID tag-based system. For the digital camera shown in FIG. 2, the transceiver signal is intercommunicated between a telecommunications processor 40 and the microprocessor 42.

Referring to FIG. 2, an image is focused by the lens section 28 upon a charge coupled device (CCD) image sensor 44, which generates an image signal from the captured image. The image signal is converted into a digital signal by an A/D converter 46, processed by the microprocessor 42 and stored in a memory 48. The memory 48 may take any number of conventional forms, including a removable memory such as a memory card or a small hard drive card. The image signal, as well as content data related to the image, may be viewed on a liquid crystal display (LCD) 50. As a further feature, personality data descriptive of the user may be stored in a personality file 52, as described in detail in the aforementioned U.S. Pat. No. 6,396,537, which is incorporated herein by reference. The personality data relates one or more interests of the user to at least a portion of the content data in the content database 14.

In the case of the film camera 26 shown in FIG. 3, the lens section 28 forms an image upon a photosensitive film 54. Preferably, the film 54 is an Advantix™ film including a magnetic portion 56 which can store the personality data, as well as additional data received by the transceiver section 30. Recording on the magnetic portion 56 is coordinated with a motion control interface 58 such that recording occurs when the film 54 is in motion, e.g., during film advance between exposures. For the film camera shown in FIG. 3, the processing subsystem 12 may include a photofinishing capability for developing and scanning the film, or such development and scanning may be provided at some ancillary facility.

When the digital camera 24a or the film camera 24b is brought into the communicating range of the attraction site, and a photograph is taken at that site, an exchange takes place between the camera and the corresponding wireless communication station via a wireless link 60. More specifically, location data is uploaded to the camera 24a or 24b, which is eventually processed to establish identification of the site. For both types of cameras, the captured image is stored in an image recording memory (the memory 48 in the digital camera 24a or the Advantix™ film 54 in the film camera 24b), and the selected content data is stored in the memory 48 or in the magnetic portion 56 on the film 54, and therewith appended to or associated with the image. In typical usage of this system, the user actuates a capture release in the user interface 31, the respective camera captures the selected image, and the location data is captured by the camera. In particular, the location data would ordinarily not be captured by the camera until the user actually captures an image. This allows the user to point the camera and to frame an image without initiating any data transfer between the camera and the attraction site. Consequently, although it does not have to be the case, the image capture and the data transfer ordinarily occur contemporaneously, and substantially simultaneously. With the film camera 24b, the selected data is appended to the image data somewhat later in time, e.g., when the film is advanced. With the digital camera, the data transfer results in appending the correlated data contemporaneously with image capture. (Although not specifically disclosed, it should be understood that the camera may include a mode switch or the like so that the inventive features can be disabled, and the camera can operate conventionally to capture an image without triggering any communication between the camera and the attraction site.)

In a second embodiment, referring to part of FIG. 1, the location data may be obtained from a global positioning system (GPS) source, such as one or more GPS satellites 62. In this embodiment, a GPS receiver is provided either as part of the camera or as an attachment 64 that is separate from the main camera body but connectable through contacts (not shown) to the camera body (it may be useful to keep the main camera body small by having the GPS receiver separate from the camera). The attachment 64 also includes an antenna 66 for receiving a GPS signal from the GPS satellite 62 and an angular position sensor 68 (such as a compass and, if necessary, an inclination detector) for deriving the angular orientation of the field of view axis of the camera 24a or 24b. The latitude, longitude data obtained from a GPS processor 70 and the angular orientation of the axis of the field of view of the camera fully define the line of sight of the camera to the attraction site. The location data thus would be a set of specific GPS coordinates and a set of specific angular coordinates. Although further detail is usually not necessary, a range finder could also be used to determine the distance of the main object in the image from the camera, thus fully constraining the location of the attraction site.

In an additional embodiment, a local GPS system could be used within the confines of a particular location offering many potential attraction sites, such as a theme park or a National Park. The local GPS system would include at least two radio frequency sources, e.g., positioned in line of sight of camera users, that would combine with the radio signal from the transceiver associated with the camera to form a three signal triangulation that would serve to locate any objects within the known transmission space. Alternatively, a cellular telephone transmission can be used for triangulation. For instance, cellular telephones equipped with digital cameras provide time and date information whenever a photo is taken. In addition, the location of the user can be determined by triangulation according to their proximity to cell phone towers.

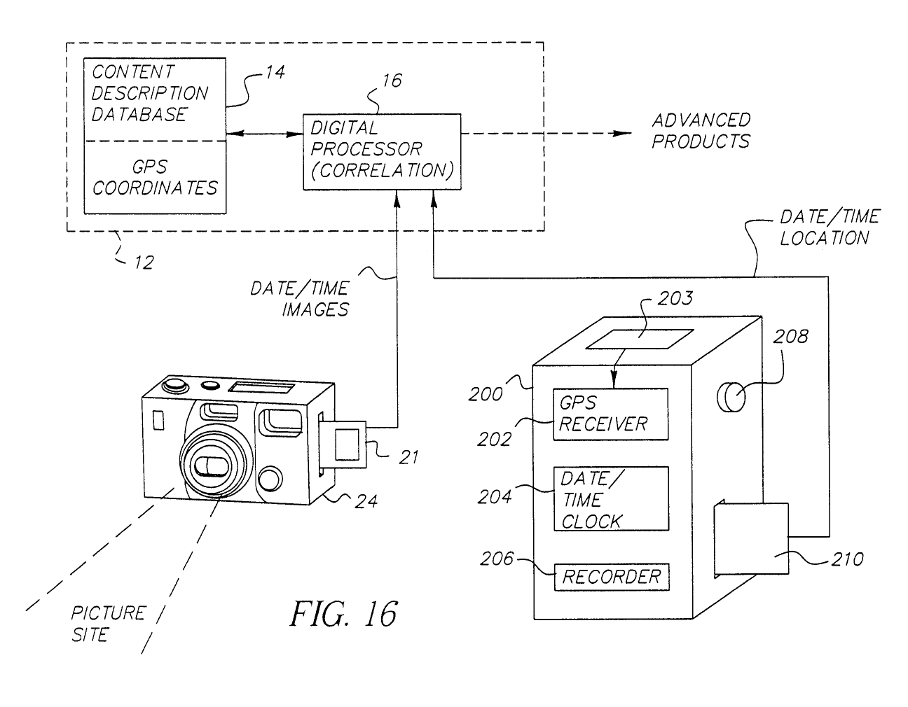

In yet another embodiment shown in FIG. 16, the GPS system is configured as a separate recording device 200 that is carried around by the photographer as the picture sites are visited. The device 200 contains a GPS receiver 202 connected to an antenna 203 for receiving location coordinates from a GPS satellite, a clock 204 for generating date/time information corresponding to the received coordinates, and a recorder 206 for recording the GPS coordinates together with the date/time of their reception. Such a device 200 can be a small package that is, e.g., attached to a belt, carried in a bag, or the like. It may run continuously, providing a continuous stream of date/time and GPS information, or it can run intermittently under control of a start button 208. The GPS and date/time information is recorded upon internal memory in the recorder 206 and/or in a memory card 210 that is removable and delivered to the processing subsystem 12. The camera 24, whether film or digital, also includes a date/time clock generator that provides date/time information corresponding to each image capture. The captured images and their corresponding date/time information are delivered to the processing subsystem 12 on the memory card 21, or recorded on a film if the camera is a film camera (e.g., recorded on the magnetic recording area of APS film). As yet another alternative, the camera 24 could be a single use camera with a clock attachment for producing date/time information that is recorded on the film, or on a recording device in the camera. The whole single use camera is then delivered to the processing subsystem 12.

For the embodiment shown in FIG. 16, the date/time information from the camera 24 and the device 200 is used to correlate the location information from the GPS receiver 202 with the images captured by the camera 24. More specifically, the content description database 14 contains a library of stored content, including images, pertaining to the picture sites. The camera 24 captures images at a particular picture site location and records date/time information with the images, and the recording device 200 carried by the photographer records date/time and location information. The digital processor 16 then correlates the date/time information recorded by the camera 24 and the recording device 200 in order to relate the location information to the captured images and to the content stored in the database 14. A special feature of this approach is that the correlation can be used to identify a subset of stored content, including images, in the library that pertain to the particular picture site location. This is useful in reducing the amount of content that must be examined and processed. The processor 16 then processes the subset of stored content, including images, and the captured images to identify the stored content of the picture site that is shown in the captured images. One way of processing the data is to use an image processing algorithm, such as the aforementioned image identification methodology, for correlating objects found in the subset of stored images with objects in the captured images, thereby identifying the content of the picture site shown in the captured images. Finally, the product composer 15 (see FIG. 1) generates an enhanced image product by associating the identified stored content of the picture site with the captured images to generate a new image product.

In yet another variation of the embodiment shown in FIG. 16, the location information can be manually entered via a device such as a keypad (in place of the GPS receiver 202) by the photographer and stored as above with the date/time information from the clock 204. Furthermore, if the database should contain content about objects that are situated between picture sites, the processor 16 may correlate the date/time information recorded by the camera 24 and the recording device 200 in order to relate the location information to the captured images and to a plurality of picture sites in the database corresponding to the captured images. Then, the processor 16 uses the locations of the plurality of picture sites to interpolate an estimated location relative to, e.g., between, the plurality of picture sites, and thereby identify stored content in the database associated with the estimated location. Then, the product composer 15 generates an enhanced image product by associating the identified stored content of the estimated location with the captured images to generate a new image product. This process will work not only for content unassociated with any picture site, but also picture sites encountered during the travel of the photographer, but for which no image was captured. It should also be noted that the correlation can be performed on just the time information, and such is meant to be understood when reference is made to date/time information.

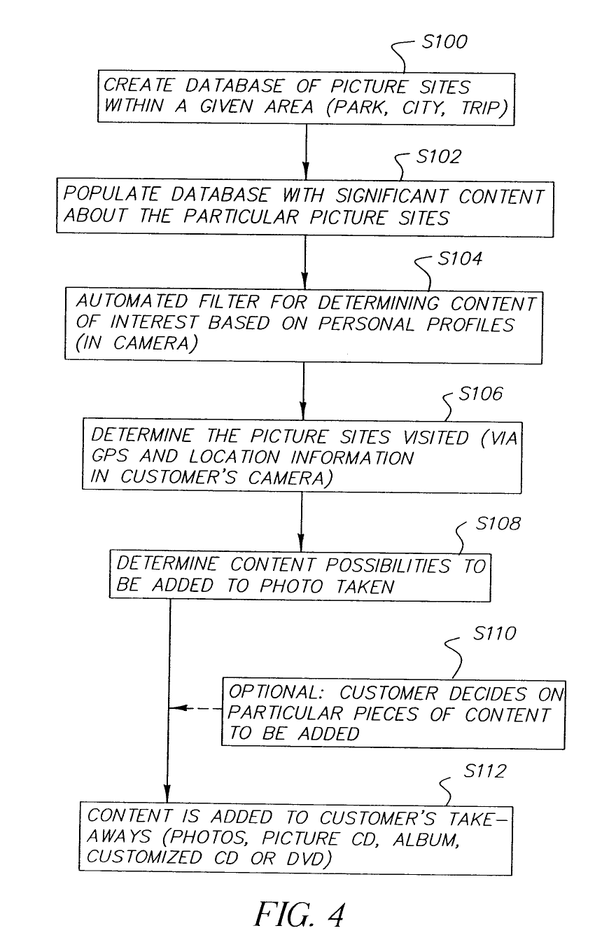

FIG. 4 illustrates the process steps involved in adding content to the images captured by a customer/photographer. The first step S100 is to create a database of picture sites, which would typically be done within a certain geographic area, or in relation to a certain activity, e.g., within a park or a city, or during a trip. Content is collected from various sources, and in step S102 the database 14 is populated with significant content about the particular picture sites. Certain content may have more relevance to some people than others; this is reflected in the personality files 52 in the camera (FIG. 2). For instance, some people may have more interest in historical aspects of the attraction sites than other people, and the personality files reflect that interest. Consequently, in step S104 an automated filter may be employed to determine content of interest based on the personal profiles. The processing subsystem 12, in step S106, utilizes the location data captured by the camera 24a or 24b to determine the picture sites visited.

The processing subsystem 12 may utilize a variety of techniques to determine the picture sites visited, depending on the nature of the location data. If the location data is an actual attraction site ID code that is transmitted to the camera from the communication stations 22, the processor 16 will access a reference list of likely attraction sites and their site IDs (which may be part of the content database 14), and then match the transmitted site ID with the reference list to determine the picture site visited. If the location data is a set of GPS coordinates, perhaps enhanced by angular coordinates, or coordinates obtained by local triangulation, the processor 16 will compare the coordinates to a database of coordinates for given attraction sites to determine the picture site visited. The angular coordinates may be necessary when more than one attraction site is visible from the same set of GPS coordinates.

From the knowledge of the picture sites visited, the digital processor 16 accesses the content database 14 and determines the content possibilities (step S108) that can be added to the photo that has been captured. (An optional step S110 may been employed, e.g., utilizing optimal input from use of the monitor 17, to allow the customer to decide on the particular pieces of content from the database 14 that are to be added to the photo.) Finally, in step S112, the enhanced image products 18 are composed by the product composer 15 by adding the content to the customer products, whether that may be photos, Picture CDs, an album, a customized CD or DVD, or the like. For instance, photo albums may be automatically created according to such methods as disclosed in commonly assigned U.S. Pat. Nos. 6,288,719 and 6,362,900, both entitled “System and Method of Constructing a Photo Album”, and both incorporated herein by reference.

As shown in FIG. 1, there is provision for on-line registration 80 for use of the enhanced photographic system. In addition, there is a local registration site 82 which provides for local registration and camera rental 84. Local registration can be completed through a data terminal 86, through which personal information may be entered. For instance, personal profile data 88 may be entered at this time. Also, on-line registrants may still visit the local registration site 82 to pick up a rental camera (where the rental could be arranged on-line).

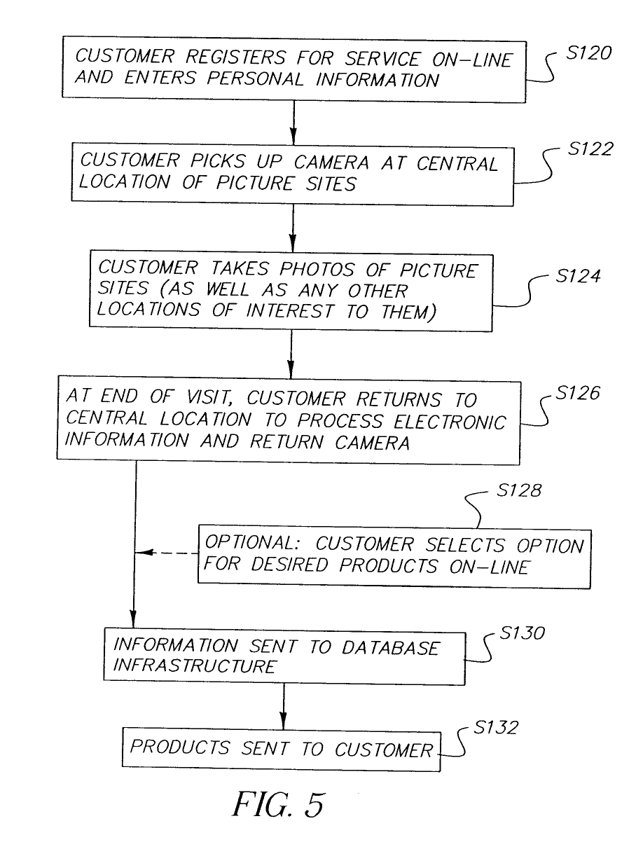

FIG. 5 shows the process for the disclosed photographic system, beginning with on-line registration. In step S120, a customer registers for service on-line, for example through the Internet, and enters personal information, such as, name, address, e-mail address, and so on. Then, the customer comes to a central site (step S122), such as the local registration site 82, and picks up a camera at the camera rental site 84. Then, in step S124, the customer takes photos of the attraction sites 20, as well as other locations that may not have any communication stations 22. At the end of the visit to the attraction site, in step S126, the customer returns to the central location, for example the local registration site 82, where the processing subsystem 12 may be located. Here, the customer returns the camera 24a or 24b for processing, and selects the enhanced image products 18 that may be desired. (Alternatively, in a step S128 the customer may select the desired products on-line either preceding the visit or through a mobile on-line connection during the visit.) The images and the location information (record 23) are provided to the processing subsystem 12 in a step S130. The products are composed by the product composer 15, generated by the processor 19 and then provided to the customer (step S1132), either on the spot or through e-mail, postal service, or the like.

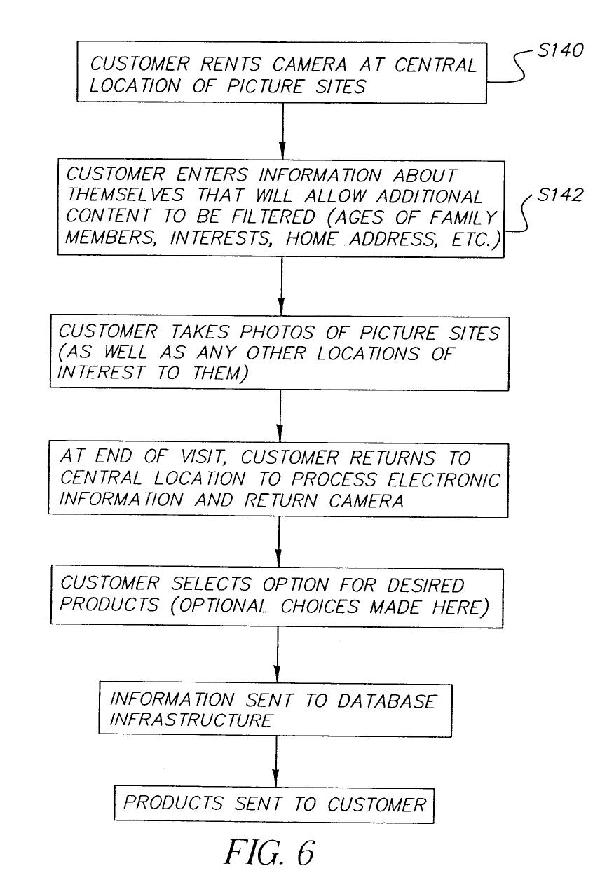

FIG. 6 shows the process for the disclosed photographic system, beginning with on-site registration. In step S140, the customer arrives at the local registration site 82, registers for the event and rents a camera. Except for on-site registration, the process resembles that of FIG. 5. One difference, which can also be available to on-line registrants, is shown in step S142. Information entered at registration, in step S142, includes personal information that allows additional content to be filtered, that is, certain personal information such as ages of family members, personal interest, home address, etc., that can be used to select particular content from the content database 14. The remaining steps are substantially the same as those described in connection with FIG. 5.

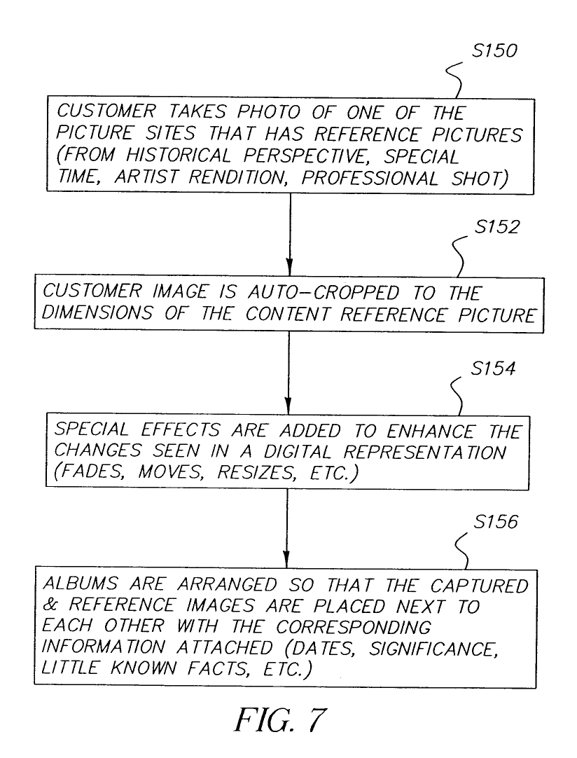

Various types of enhanced photographic products 18 may be produced in accordance with the invention. As shown in FIG. 1, an album 18b may be produced with two (or more) photos: one taken by the customer/photographer and the other a stock photo selected from the content database 14. FIG. 7 shows a process for selecting a stock photo from the database 14 that relates to the image taken by the customer. In this particular application, the content database 14 has been populated with stock images that relate to particular attraction sites. The images may, for example, represent different historical perspectives, a special or different time, an artist rendition, or just a current professional shot of the same attraction site. In step S150, the customer takes a photo of one of the attraction sites 20 that has corresponding reference pictures stored in the content database 14. When the customer-captured image is processed at the processing subsystem 12, it is auto-cropped in step S152 to the dimensions of the content reference photo from the database. In step S1154, special effects may be added to enhance the differences or changes between the images, such as fades, moves, resizes, and so on. Then, in step S156, an album is generated so that the captured and reference image are placed next to each other (as shown by the album 18b in FIG. 1) with corresponding information optionally attached or included with the images, such as dates, significance, little known facts, and so forth.

It should be understood that the only requirements for the process shown in FIG. 7 are that the customer photographs a site having reference images (step 150) and that the captured and reference image(s) are presented in an attractive manner (step 156) in the enhanced product 18. The intervening stages of cropping (step S154) and special effects (step S156) are desirable, but optional.

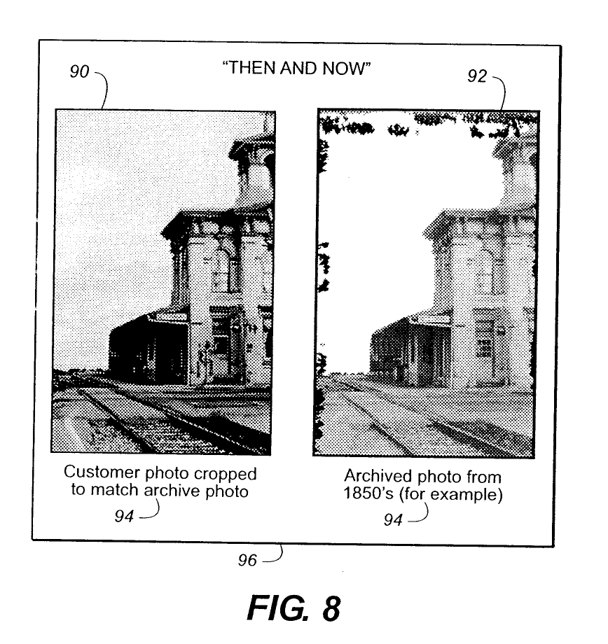

A particular example of this technique is shown in FIG. 8 for a currently captured image 90 of a train depot in an historical park (e.g., a battlefield) and an archived stock photo 92 of the same scene from a century or more earlier. The current image has been auto-cropped (step S1152) to match the archived photo, and corresponding information 94 has been added to the photos (step S156). While not a necessary feature of the invention, it may be aesthetically desirable to present the two (then and now) photos on a common album page 96.

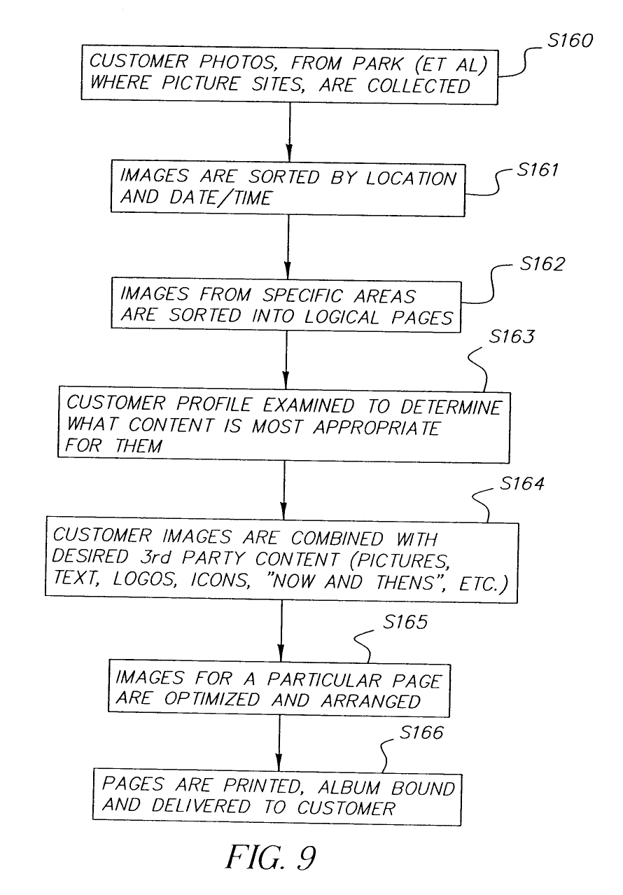

FIG. 9 describes a technique for generating an album from customer photos, using content data related to the attraction sites. Initially, in step 160, the customer photos are provided to the processing subsystem 12. The images are sorted in step 161 by date/time and location, as contained in the record 23 received by the processing subsystem 12. Then, in step 162 the images from specific areas are sorted into logical pages, using techniques such as described in the aforementioned auto-albuming patents (U.S. Pat. Nos. 6,288,719 and 6,362,900). The customer profile data 88, which may be incorporated into the record 23 or obtained through on-line registration 80 or local registration 82, is examined in step 163 to determine what content is most appropriate for the photos. For example, the age of the customer may dictate youthful vs. adult information. In step 164, the customer images are combined with content from the database 14 and then optimized and arranged for a particular page (step 165). Finally, the pages are printed and the album is generated and delivered to the customer (step 166).

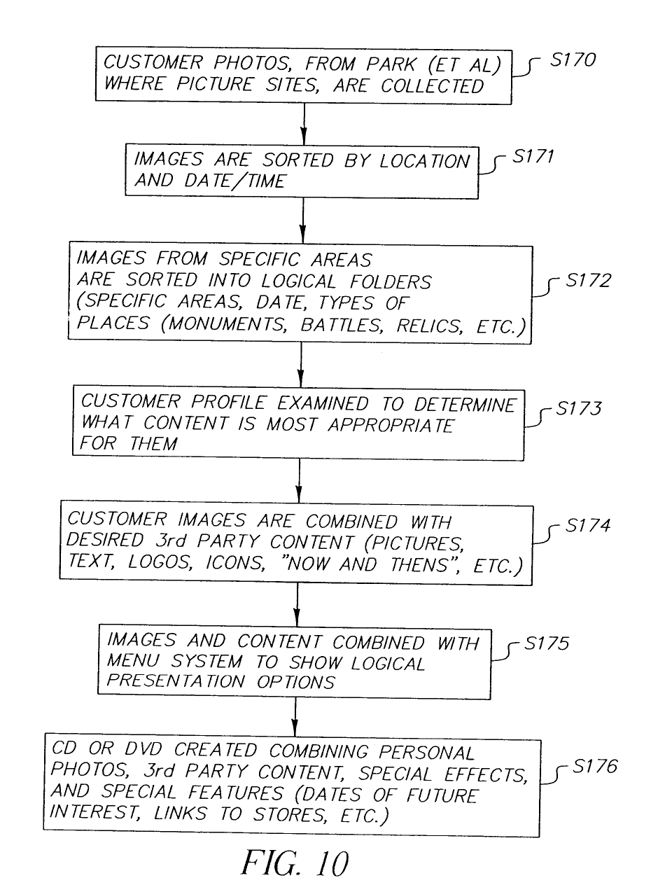

FIG. 10 describes a technique for generating a CD or DVD product 18c from customer photos, using content data related to the attraction sites. The initial steps S170-S174 are similar to steps S160-S164 described in relation to FIG. 9, except to the extent that the images from specific areas are sorted into file folders in step 172 (instead of pages), inasmuch as the CD (or DVD) generating program produces data folders rather than pages. Since the CD (or DVD) program provides access to a variety of presentation offerings, in step S1175 the image and content are combined with the program's menu system to show the presentation options available to the customer. Then, in step S176, a CD or DVD is generated from the currently captured personal photos and the image content withdrawn from the content database 14. It should be further noted that the CD or DVD may be interactive in the sense that a number of logical presentation options may be generated and then selected by clicking on the appropriate menu entry.

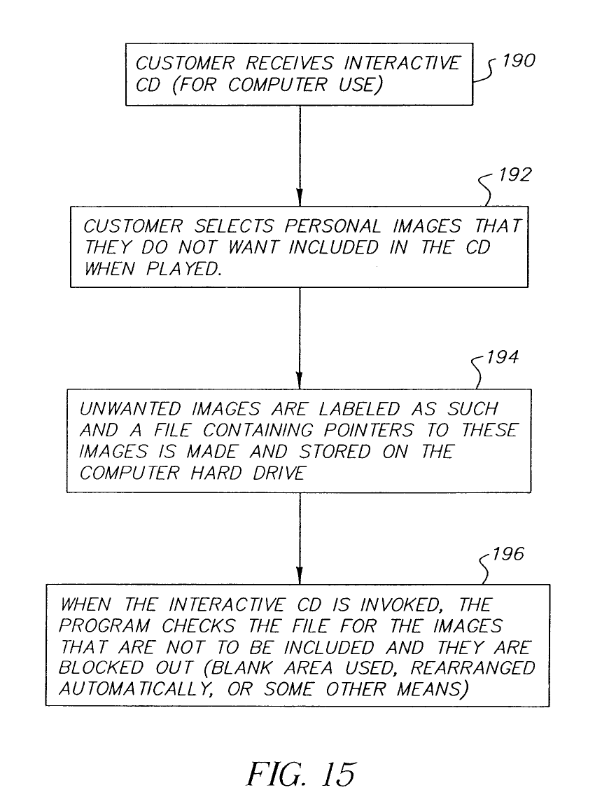

In an automated creation system for a CD or DVD application, the customer may not want to include some of the photos that were taken by the customer, even though the images might be acceptable insofar as quality or some other measure is concerned. The method shown in FIG. 15 allows the customer to select images that they do not want included in a display from the interactive CD or DVD. More specifically, in step 190 of FIG. 15 the customer receives an interactive CD or DVD specifically for use on his or her computer. In step 192, the customer selects personal images that they do not want included in the CD or DVD when played. The unwanted images are labeled as unplayable in step 194 and this information is stored in a special file (e.g., as a file containing pointers to these images) and stored on the hard drive of the customer's computer. When the interactive CD or DVD is inserted into the computer in step 196, the display program checks the file for images that are not to be included and they are blocked out.

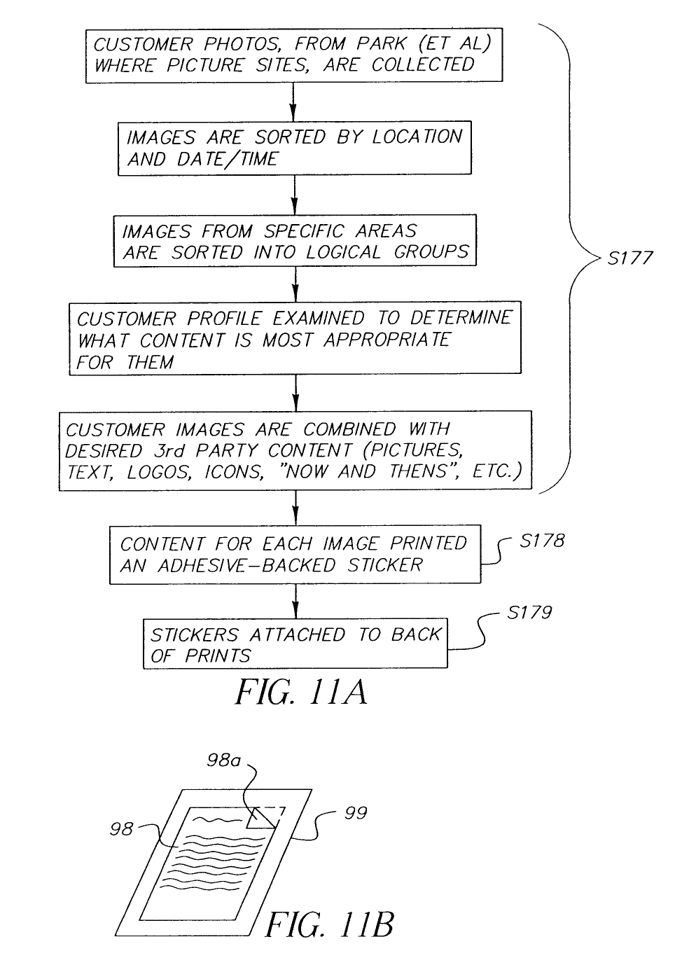

FIG. 11A describes a technique for generating photographic prints that are enhanced to include stickers on their backs with the content information printed on the stickers. The initial steps S177 are the same as steps S160-S164 as shown in FIG. 9. However, instead of arranging the content to be printed or shown with images of the corresponding attraction sites, the content is printed on stickers in a processing step S178 and the stickers are automatically attached to the back of the photographs in step S179 by the photofinisher. As shown in FIG. 11B, the stickers 98 can be manually peeled by a corner 98A thereof from the back of print 99. This is useful in a situation where the customer is employing the photos in an application, like a scrapbook, of the customer's own design and where the descriptive sticker can be fastened wherever desired by the customer in the particular application.

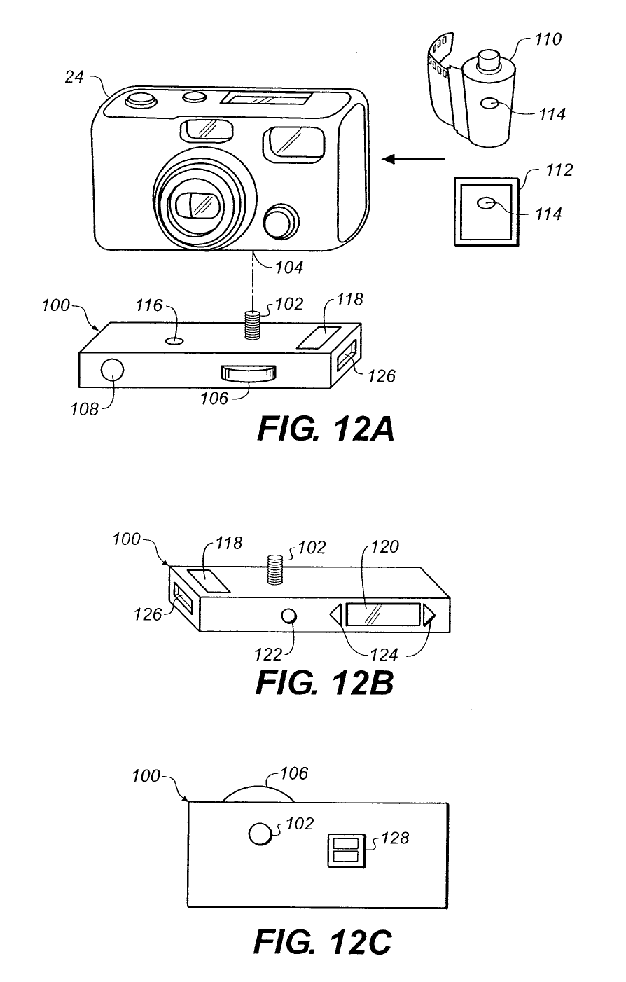

FIGS. 12A and 12B describe an attachment 100 that may be used with either the digital camera 24a or film camera 24b as a recording device to collect meta data associated with the attraction sites 20 (instead of having this capability incorporated into the camera 24, as suggested in FIG. 1). In FIG. 12A, the attachment 100 is shown as an elongated device with a screw 102 for connecting with a tripod connection 104 on the camera 24 (FIG. 12C shows a bottom view of the attachment 100, revealing the tripod screw connection 102). A thumbwheel 106 is used to attach the tripod screw 102 to the camera. The attachment 100 includes an RF transceiver 108 for communicating with the station 22 at an attraction site 20 (the transceiver 108 may be also used as a wireless connection for communicating with a computer/kiosk and downloading the location records to the processing subsystem 12).

Location data from the attraction sites 20 is collected by the transceiver 108 and stored in a memory in the attachment 100 (this memory is not shown but is similar to the camera memory shown in FIG. 2). Image data captured by the camera 24 is stored either in a film roll 110 or a memory card 112 (depending on whether the camera is a film camera or a digital camera). In either case, it is necessary to maintain an association between the images and the location data gathered by the attachment 100. In the present embodiment, this association is provided by a short range RF transmitter 114 attached to the film roll 10 and the memory card 112, which contains and transmits an ID number for the film roll or memory card. The attachment includes a receiver 116 for receiving short range RF from the transmitter 114.

Another requirement is for the attachment to know when to record location data, and which frame to associate the location data with. For a film camera 24b, a micro-electro-mechanical system (MEMS) motion-detecting device 118 is provided on the attachment 100 for detecting motion of the film advance mechanism in the camera, and thereupon indicating a readiness to receive location data synchronized with that particular frame advance. For a digital camera 24a, the attachment 100 includes a user interface comprising an LCD information display 120, a menu button 122 and buttons 124 for cycling through information and otherwise correcting or specifying information. These features are used to synchronize the frame sequence of digital image capture with provision of location data from the attraction sites 20.

Finally, the data gathered by the attachment 100—including the location data, the film roll or memory card ID, and the synchronization of each image with the location data—must be provided to the processing subsystem 12 through an output interface. For instance, such information can be downloaded through the RF transceiver 108 or through a computer connector 126, such as a USB connector. In addition, if the processing subsystem 12 were to include a docking unit, the data may be downloaded through a dock connection 128, such as shown in the bottom view of the camera attachment in FIG. 12C.

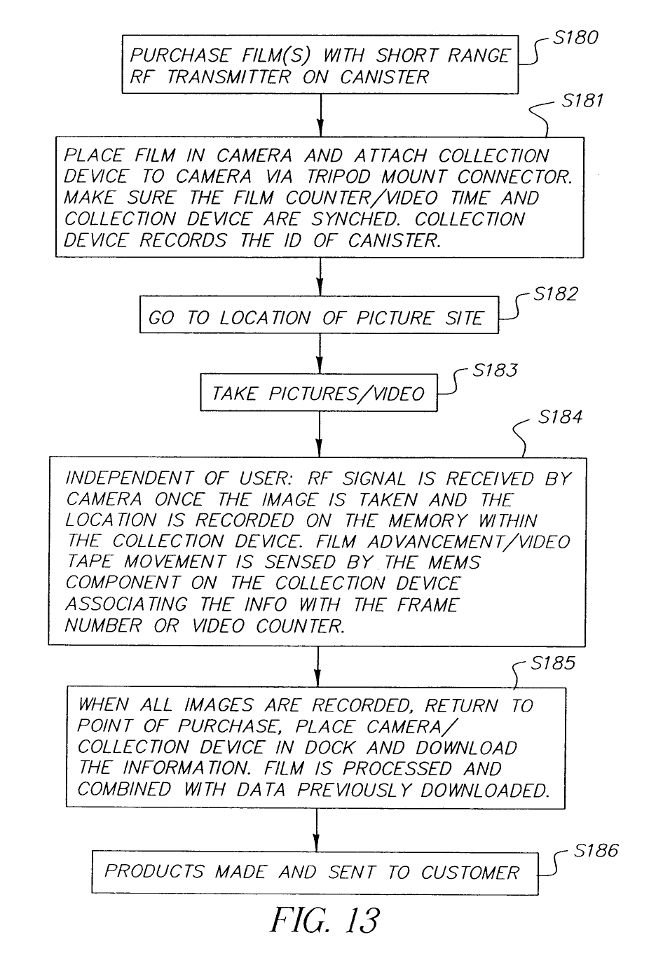

FIG. 13 shows a technique for using the attachment 100, in particular with a film camera. To begin with, film is purchased in step S180, for example at the local registration site 82, having the short range RF transmitter 114 already attached to the film canister. Then in step S181 the film is inserted into the camera and the collection device 100 is attached to the camera. It may be desirable to utilize the LCD display 120 to synchronize the film counter/timer on the camera with the counter/timer of the attachment 100. Then the customer takes the camera plus attachment to an attraction site (step S182) and takes some photos (step S183). As the picture is taken, in a step S184 independent of any user interaction, an RF signal is received by the transceiver 108 from a communication station 22. Meanwhile, film advance is sensed by the MEMS device 118 and location data is recorded on memory within the attachment 100, including a reference to the frame or image number. When all images are recorded, the camera is returned to the site 82 or to the processing subsystem 12, and the location data is downloaded (step 185)—either through the transceiver 108, the computer connection 126 or through the dock connection 128. The desired products are generated and given to the customer (step 186). A similar process is followed for use of the attachment 100 with a digital camera.

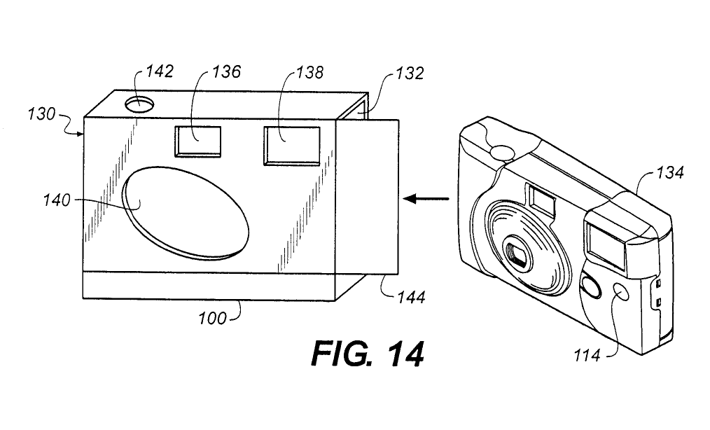

In the case of a single use camera as shown in FIG. 14, the attachment 100 shown in FIG. 12A may be configured to fit within a bottom portion of a flexible sleeve 130 having an opening 132 on one side thereof for receiving a single use camera 134. The sleeve 130, which holds the attachment 100 in close association with the camera 134, also includes holes 136, 138, 140 and 142 for the viewfinder, flash lens/shutter and shutter button, respectively, of the camera 130. (Given the flexibility of the sleeve, the hole 142 for the shutter button may be omitted if the place to push it is clear to the consumer—e.g., either the sleeve is transparent or marked with the button location.) A short range RF transmitter 114 is attached to the single use camera 134. In operation, the camera 134 is inserted into sleeve 130, the door 144 is closed, and the operation follows the steps described in connection with FIG. 13.

The foregoing data gathering techniques can be adapted to a video camera using the same means, only synchronizing the collection device to the time of the tape as opposed to the exposure number on the film.

In summary, the enhanced photo products provided in accordance with the various embodiments of the invention may include without limitation some or all of the following:
Additional related images (e.g., pictures taken in better weather, historical photos related to the site, artist's renditions of the site, professional shots of the site).
Additional information (text about the site, maps of the site, logos and graphics associated with the sites, taking conditions).
Panoramas and 360s (e.g., putting consumer images into a historical panorama).
Virtual reality products, e.g., utilizing such platforms as Apple Computer's QuickTime VR™.
Movies (from the site, from 3^{rd} parties, wholly owned by 3^{rd} parties).
Re-enactments of historic events at the site (photos and movies).
Enhancements to personal photos (auto crop, auto zoom, different areas blurred/sharpened, special effects, highlighting areas of historical interest).
“Then and now” pictures/animations showing the differences from the present consumer-captured images and historic images from similar vantage points.
Features on the CD or DVD allowing for unwanted pictures to be removed from the playback.

With location information and other (stock) photos related to the captured images, it is possible to automatically create a 360° panorama from the consumer's photos and to fill in missing pieces of the consumer-captured (partial) panorama with stored images. It is further possible to automatically identify objects within the photo and identify key pieces of the photo or attach other content in a digital representation like Picture CD. This object identification also allows for general image enhancement of sharpness, contrast of specific objects, color enhancement, and the ability to create multiple views from the same photo (different areas in focus, for example). It can also allow for automated comparisons of photos taken today and those of previous timeframes, including antiquated ones and artist's renditions.

While the processing site 12 has been shown as being external to, and separate from, the camera subsystem 10, in some embodiments of the invention the processing may be shared with, or wholly within, the camera 24. For example, the activity of analyzing and identifying the picture site, instead of being carried out by the processor 16, may instead be carried out by the processor in the camera 24, for example by the microprocessor 42 in the digital camera 24a. For this purpose, the camera needs to access the database 14. This can be done by uplinking the camera to the database 14 by any conventional means, such as a network connection (e.g., the Internet) or a tethered connection to the processing subsystem 12. Alternatively, the database can be resident in, or downloaded to, the camera 24 (e.g., in the memory 48) or it can be stored on removable memory (such as the removable memory 21 shown in FIG. 1) that can be introduced to the camera 24. Furthermore, the generation of the enhanced photo products can be done within the camera 24 by the microprocessor 42 and communicated to an external receiver, such as through the wireless transceiver 30 or like type of connection. This is particularly feasible where the product is intended for Internet distribution. Alternatively, the functionality of the product composer 15 can be included in the microprocessor 42 and rendered product code can be provided by the camera 24 through suitable connection with an external printer, CD or DVD writer, or the like. Since, in these embodiments, the identification of the picture site is performed in the camera 24, and content pertaining to the picture site is accessible within and by the camera itself, the processor 42 in the camera can identify venue specific products from the database and offer the photographer a choice of products, e.g., as a suitable menu of choices presented on the LCD 50.

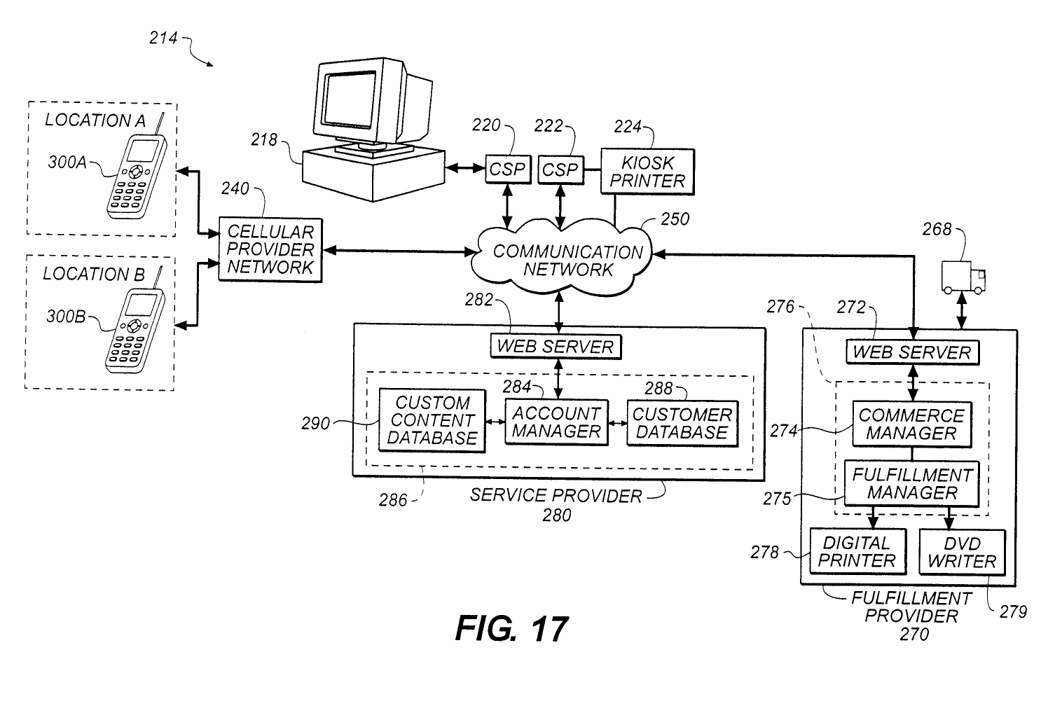

Referring to FIG. 17, there is illustrated a system 214 for capturing digital images along with location and time information, and using the images and information to provide customized photo products. A first camera phone 300A, located at a first location A, and a second camera phone 300B, located at a second location B, can communicate using a cellular provider network 240. The cellular provider network provides both voice and data communications using transmission devices located at cell towers throughout a region. The cellular provider network 240 is coupled to a communication network 250, such as the Internet.

The communications network 250 enables communication with a service provider 280. Service provider 280 includes a web server 282 for interfacing with communications network 250. In addition to interfacing to communications network 250, web server 282 transfers information to a computer system 286 which manages images and information associated with various customers and with image content associated with different locations and events.

The computer system 286 includes an account manager 284, which runs software to permit the creation and management of individual customer photo imaging accounts and to also permit the creation and management of collections of custom content images, such as professional images, and other content associated with various events and locations. The customer images and associated information are stored in a customer database 288. The customer account information can include personal information such as name and address, billing information such as credit card information, and authorization information that controls access to the customer's images by third parties. The professional images and other custom content associated with the supported events and locations is stored in custom content database 290.

Thus, the customer database 288 stores customer image files and related metadata, such as location and time information which identifies the location at which the image was captured, and the time of capture. The custom content database 290 stores custom content captured images, such as professional captured images, files and related metadata, for example images of particular vacation destinations (e.g. New York City, Cape May, etc.) and particular events (Rose Bowl Parade, Professional Sports events, Major Concerts, etc.). The custom content database 290 includes an index providing the GPS coordinate boundaries of locations, and the time boundaries of events, so that locations (such as Cape May, or Yellowstone National Park) and events (such as the Rose Bowl Parade) can be identified.

The communications network 250 enables communication with a fulfillment provider 270. The fulfillment provider 270 produces and distributes enhanced photo products. The fulfillment provider 270 includes a fulfillment web server 272, and a fulfillment computer system 276 that further includes a commerce manager 274 and a fulfillment manager 275. Fulfillment requests received from service provider 280 are handled by commerce manager 274 initially before handing the requests off to fulfillment manager 275. Fulfillment manager 275 determines which equipment is used to fulfill the ordered good(s) and/or services such as a digital printer 278 or a DVD writer 279. The digital printer 278 represents a range of color hardcopy printers that can produce various photo products, including prints and photo albums. The hardcopy prints can be of various sizes, including “poster prints”, and can be sold in frames. The DVD writer 279 can produce CDs or DVDs, for example PictureCDs, having digital still and video images and application software for using the digital images.

After fulfillment, the ordered goods/services are returned to the ordering party by a delivery means, for example, but not by way of limitation, a transportation vehicle 268. However, the embodiment is not limited to returning the ordered goods/services to the ordering party, and the goods/services can also be delivered to a third party as instructed by, for example, the ordering party.

System 214 also includes a customer computer 218 connected through a communication service provider (CSP) 220 and the communication network 250 to the service provider 280. Also, included in system 214 is a kiosk printer 224 which communicates with the communication network 250 and service provider 280 via a communication service provider (CSP) 222.

In some embodiments, the web server 282 at the service provider 280, or the web server 272 at the fulfillment provider 270 can create examples of various photo products that can be provided by the fulfillment provider 270, as described in commonly-assigned U.S. patent application Ser. No. 09/576,288, filed May 23, 2000, entitled “Method For Providing Customized Photo Products Over A Network” by Parulski et al., the disclosure of which is incorporated herein by reference. This includes information describing photo product options, for example, album features such as providing various background colors or textures, page numbers, page captions, and image captions. The album pages can be bound in a cover, or can include holes to permit the pages to be inserted into a standard binder, such as a three-ring binder. These album feature options can be demonstrated via software programs, for example, JAVA applets, MPEG or QuickTime movies, or Shockwave files, which depict the functionality of features that the customer can choose.

The customer database 288 at the service provider 280 includes information describing each customer account, including user billing information. The billing information can include a payment identifier for the user, such as a charge card number, expiration date, user billing address, or any other suitable identifier. The customer database 288 also provides long-term storage of the uploaded images for each user. In this case, stored images are accessible (e.g., viewable) via the Internet by authorized users, as described, for example, in commonly-assigned U.S. Pat. No. 5,760,917, entitled “Image distribution method and system” to Sheridan, the disclosure of which is herein incorporated by reference. The customer database 288 can be distributed over several computers at the same physical site, or at different sites.

Whenever a photo product is purchased by the user, the service provider account manager 284 can communicate with a remote financial institution (not shown) to verify that the payment identifier (e.g., credit card or debit card number) provided by the customer is valid, and to debit the account for the purchase. Alternatively, the price of the photo product can be added to the user's monthly bill paid to the service provider.

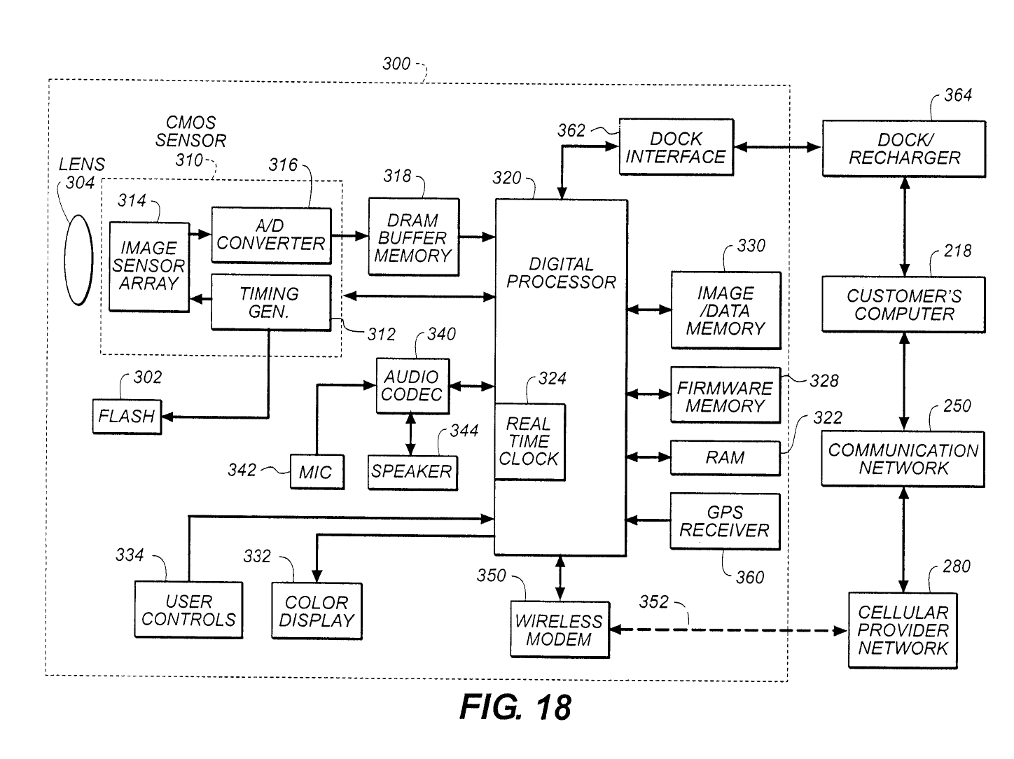

FIG. 18 depicts a block diagram of a camera phone 300 used in the digital photography system of FIG. 17. The camera phone 300 includes a lens 304 which focuses light from a scene (not shown) onto an image sensor array 314 of a CMOS image sensor 310. The image sensor array 314 can provide color image information using the well-known Bayer color filter pattern. The image sensor array 314 is controlled by timing generator 312, which also controls a flash 302 in order to illuminate the scene when the ambient illumination is low. The image sensor array 314 can have, for example, 1280 columns×960 rows of pixels.

In some embodiments, the digital camera phone 300 can also store video clips, by summing multiple pixels of the image sensor array 314 together (e.g. summing pixels of the same color within each 4 column×4 row area of the image sensor array 314) to create a lower resolution video image frame. The video image frames are read from the image sensor array 314 at regular intervals, for example using a 30 frame per second readout rate.

The analog output signals from the image sensor array 314 are amplified and converted to digital data by the analog-to-digital (A/D) converter circuit 316 on the CMOS image sensor 310. The digital data is stored in a DRAM buffer memory 318 and subsequently processed by a digital processor 320 controlled by the firmware stored in firmware memory 328, which can be flash EPROM memory. The digital processor 320 includes a real-time clock 324, which keeps the date and time even when the digital camera phone 300 and digital processor 320 are in their low power state.

The processed digital image files are stored in the image/data memory 330, along with the date/time that the image was captured provided by the real-time clock 324 and the location information provided by GPS receiver 360. The image/data memory 330 can also be used to store other information, such as phone numbers, appointments, etc.

In the still image mode, the digital processor 320 performs color interpolation followed by color and tone correction, in order to produce rendered sRGB image data. The digital processor 320 can also provide various image sizes selected by the user. The rendered sRGB image data is then JPEG compressed and stored as a JPEG image file in the image/data memory 330. The JPEG file uses the so-called “Exif” image format. This format includes an Exif application segment that stores particular image metadata using various TIFF tags. Separate TIFF tags are used to store the date and time the picture was captured and the GPS co-ordinates, as well as other camera settings such as the lens f/number.

The digital processor 320 also creates a low-resolution “thumbnail” size image, which can be created as described in commonly-assigned U.S. Pat. No. 5,164,831, entitled “Electronic Still Camera Providing Multi-Format Storage Of Full And Reduced Resolution Images” to Kuchta, et al., the disclosure of which is herein incorporated by reference. The thumbnail image can be stored in RAM memory 322 and supplied to a color display 332, which can be, for example, an active matrix LCD or organic light emitting diode (OLED). After images are captured, they can be quickly reviewed on the color LCD image display 332 by using the thumbnail image data.

The graphical user interface displayed on the color display 332 is controlled by user controls 334. The user controls 334 can include dedicated push buttons (e.g. a telephone keypad) to dial a phone number, a control to set the mode (e.g. “phone” mode, “still camera” mode, “video camera” mode), a joystick controller that includes 4-way control (up, down, left, right) and a push-button center “OK” switch, or the like.

An audio codec 340 connected to the digital processor 320 receives an audio signal from a microphone 342 and provides an audio signal to a speaker 344. These components can be used both for telephone conversations and to record and playback an audio track, along with a video sequence or still image. The speaker 344 can also be used to inform the user of an incoming phone call. This can be done using a standard ring tone stored in firmware memory 328, or by using a custom ring-tone downloaded from the service provider 280.

A dock interface 362 can be used to connect the digital camera phone 300 to a dock/charger 364, which is connected to the customer computer 218. The dock interface 362 may conform to, for example, the well-know USB interface specification. Alternatively, the interface between the digital camera 300 and the image capture device 10 can be a wireless interface, such as the well-known Bluetooth wireless interface or the well-know 802.11b wireless interface. The dock interface 362 can be used to download image files (which include the date/time and GPS coordinates) from the image/data memory 330 to the customer computer 218. The dock/charger 364 can also be used to recharge the batteries (not shown) in the digital camera phone 300.

The digital processor 320 is coupled to a wireless modem 350, which enables the digital camera phone 300 to transmit and receive information via an RF channel 352. The wireless modem 350 communicates over a radio frequency (e.g. wireless) link with the cellular provider network 280, which can be a 3GSM network.

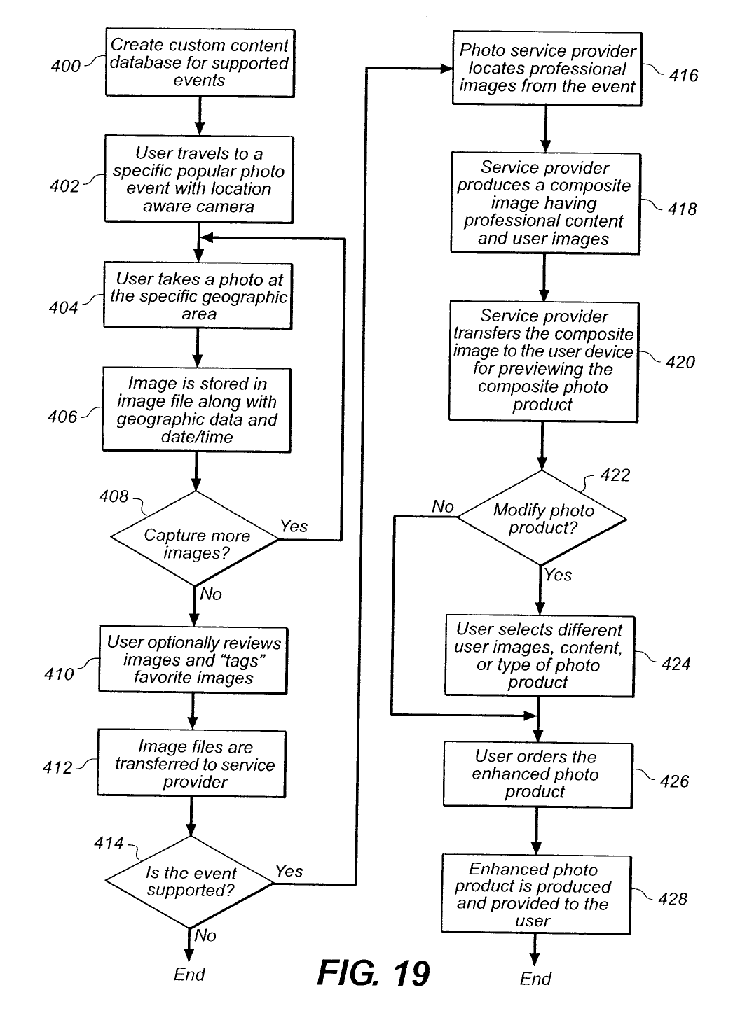

FIG. 19 depicts a flow diagram showing an embodiment of the present invention. In block 400, the service provider creates custom content for a variety of events. Some of the content can be obtained prior to the event, and some of the content is produced as the event is happening.

In block 402, the user takes a location-aware digital camera to a specific geographic area (such as location A or location B in FIG. 17) during a particular time period that corresponds to an event. The location-aware digital camera can be a digital camera phone 300 having a GPS receiver 360 (FIG. 18). Other examples of location-aware digital cameras include a digital point-and-shoot camera or a digital SLR camera incorporating a GPS receiver, a digital video camcorder incorporating a GPS receiver, and a PDA camera incorporating a GPS receiver. The geographic area can be any area of the world that corresponds to events that would be expected to involve a significant number of spectators. The geographic area can be a specific building or sports stadium, or can be larger region, such as park, gold course, festival grounds, or parade route.

In block 404, the user captures a digital photograph at the specific geographic area. Such a photograph often includes the user's family or friends at the event. In other words, the photograph might be a photo of the user's family watching the Rose Bowl parade.

In block 406, the captured digital image is stored along with geographic data and date/time. This can be done as described earlier in reference to FIG. 2. As the digital image is captured, the digital processor 320 reads the current value of the real-time clock 324 and receives the GPS co-ordinates from the GPS receiver 360. Alternatively, the time and date information may be obtained from the GPS information. The date/time and GPS co-ordinate “metadata” are then stored along with the digital image in an image file, which can be an Exif/JPEG image file that stores this metadata using the TIFF date/time and GPS tags.

In block 408, the user decides whether to capture more images. In order to capture more images (“Yes” to block 408), blocks 404 and 406 are repeated.

In block 410, if the user does not want to capture more images (“No” to block 408), the user can optionally review the captured images using the color display 332 on the camera phone 300. The user is permitted to “tag” specific images as “favorite” images, as described in commonly assigned US patent application (Docket 86,272 PRC) “Classifying digital images as favorite digital images using a digital camera” to Parulski et al., the disclosure of which is incorporated herein by reference.

In block 412, the image files are transferred from the camera phone 300 to the service provider 280, and stored in the customer database 288. The information which enables the camera phone 300 to communicate with the service provider 280 and to transfer the image files can be provided in a “network configuration file”, as described in commonly assigned U.S. Pat. No. 6,784,924, “Network configuration file for automatically transmitting images from an electronic camera” to Parulski et al., the disclosure of which is incorporated herein by reference.

In block 414, the service provider 280 automatically determines if the image files transferred in block 412 correspond to an event that is supported by the custom content database 290. In other words, does the date/time and the geographic area where the digital images were captured correspond to one of the supported events, such as the Rose Bowl Parade. This is done by comparing the GPS co-ordinates and date/time of the metadata in each of the uploaded image files to the GPS co-ordinates and time periods of the events supported by the custom content in the database 288. If the area is not supported (“No” to block 414) the process for producing a composite photo product ends. The image files transferred to the service provider can then be accessed and printed using methods known in the art.

In block 416, if the specific event is supported by the custom content database (“Yes” to block 114), the service provider 280 retrieves some of the custom content for that specific event. This custom content normally includes, but is not limited to, professionally captured photographs, graphics, templates and text. Some of this content (e.g. graphics, team photos) can be provided prior to the event, and some can be provided as the event unfolds.

In block 418, the service provider 280 produces a representation of an enhanced photo product having professional content and user images. If the user has identified one or more favorite user images in block 110, they are included in the composite image. In some embodiments, the professional content will be indicated using a “placeholder” image, which will be replaced by a final image (such as the winning score) once the event has concluded.

In block 420, the service provider 280 transfers the representation of the enhanced photo product to the user device, so that the user can view an offer for a customized photo product on a user device. The user device can be the camera phone 300. In this case, the offer can be provided to the user via the cellular provider network 280 and viewed on the color display 322. This enables the user to view the offer soon after they have captured and transferred the images in blocks 404 through 412, possibly while the event is still taking place.

Alternatively, the user device can be the customer computer 218. In this case, the offer can be provided to the user via CSP 220 and viewed on the display of the customer computer 218. This enables the user to view the offer soon after they return to their home, after the event is over.

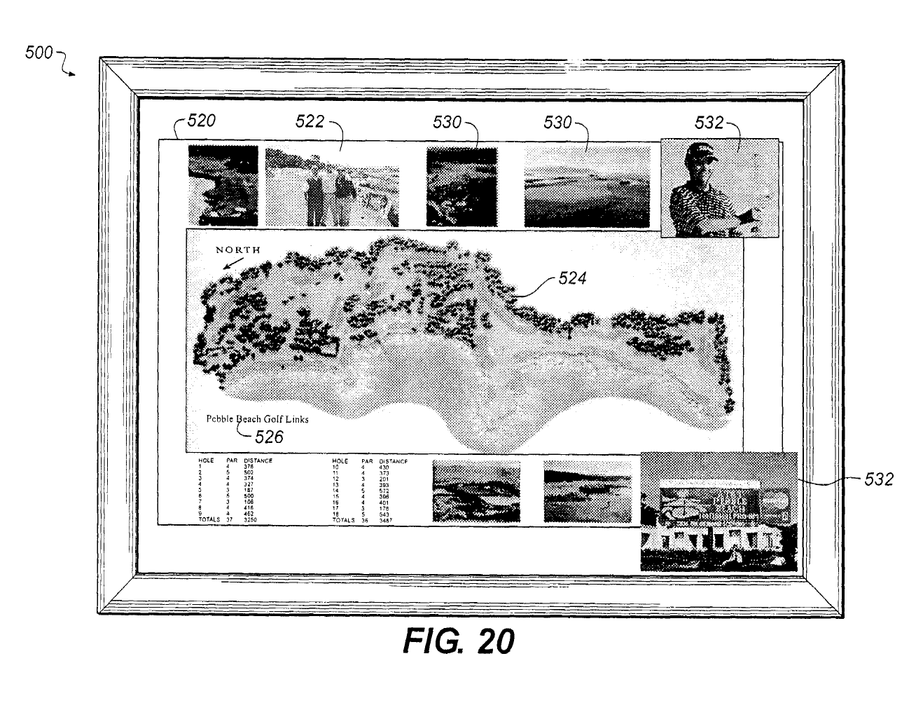

FIG. 20 depicts an example of an enhanced photo product 500, which is a framed poster print. It also shows the composite image 520, which is created by combining user images 522 with some of the custom content for the particular event, the AT&T Pebble Beach Golf Tournament 532, stored in the custom content database 290. For example, the composite image 520 includes graphics 524, titles 526, and professional photos taken of the golf course 530 and taken at the specific event including the tournament winner 532.

In block 422 of FIG. 19, the user is asked whether they want to modify the enhanced photo product. Because the color display 332 on the camera phone 300 is small in size, the composite image needs to be formatted so that the user can understand the overall size and composition of the customized photo product that they can order, and so that they can also easily view the individual images that make up the photo product.

In block 424, if the user wants to modify the photo product (“Yes” to block 422), the user selects different user images and/or professional content, or selects another type of photo product, such as an hardcopy photo album or an electronic slideshow on a DVD.

In block 426, if the user decides not to modify the photo product (“No” to block 422), or after the user modifies the photo product (in block 424), the user orders and pays for the composite photo product, as was described earlier in relation to FIG. 17.

In block 428, the composite photo product is produced and provided to the user. This may be done at the fulfillment provider 270, by printing the poster print or photo album using digital printer 278, or by writing the electronic slideshow to a DVD using DVD writer 279. The photo product can be shipped to the user using transportation vehicle 268, which may use a delivery service such as UPS. Alternatively, the composite photo product can be produced at a retail location near the user. For example, a large print or photo album could be produced using kiosk printer 224.

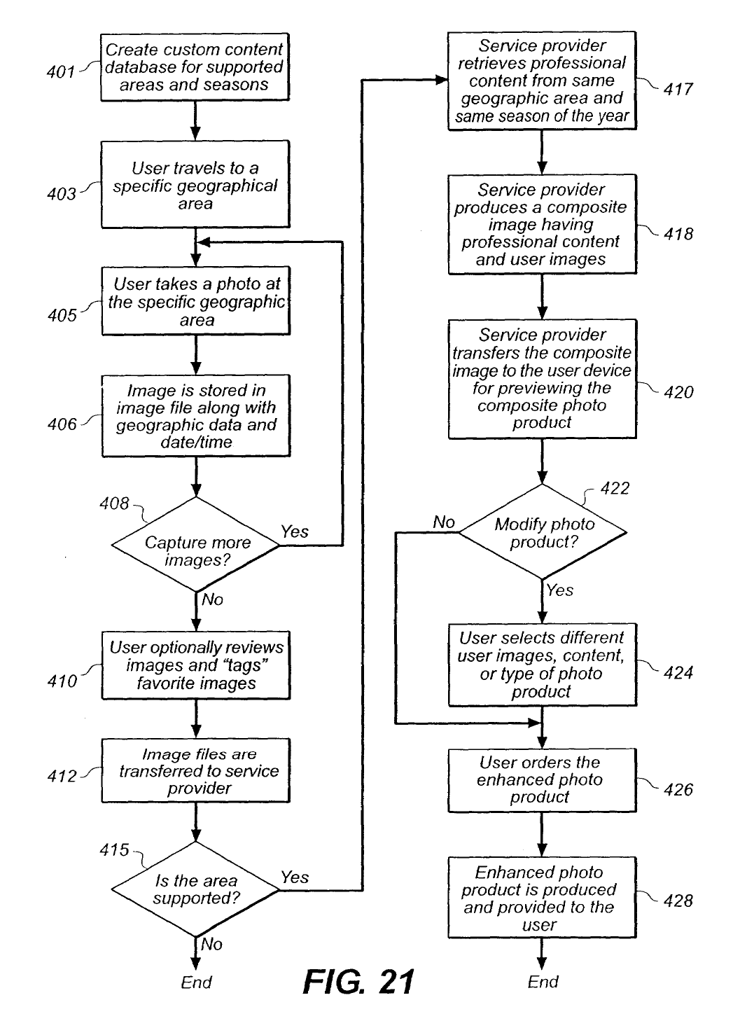

FIG. 21 depicts a flow diagram showing another embodiment of the present invention.

In block 401, the service provider creates a database of images of popular geographic areas taken at different times of the year corresponding to the changing seasons. The images would include content of recognizable objects located at the geographic areas. For example, in New York City, images of the Empire State Building, Statue of Liberty, Brooklyn Bridge, Radio City Music Hall and the Manhattan skyline, etc. would be included in the image database. Actually, thousands of images may be captured and stored for each geographic area covered. These images may be sourced from professional photographers or contributed by the general public during visits to the location.

In block 403, a user travels to the specific geographic area as part of a family vacation, business trip, or general outing. While at this geographic area, the user takes pictures with his/her digital camera, step 405. These pictures are stored in an image file that includes the image data, date, time, and geographic/location information 406.

In block 408, at the conclusion of a picture taking session, the user may optionally review and tag favorite images 410. These images are then optionally transferred to a service provider 412 for storage, sharing, or obtain imaging products.

In block 415, the service provider 280 automatically determines if the images transferred in block 412 correspond to a location that is supported by the custom content database. In other words, does the geographic area where the digital images were captured correspond to one of the supported locations, such as Niagara Falls? If the area is not supported (No to 415) the process for producing a custom product ends.

In block 417, the service provider retrieves professional content from the custom content database with the same geographic area and same season of the year as the user's images. Upon receipt of the images the user may request that a composite image product be created using one or more user's images in combination with images stored in the service provider's custom content database.

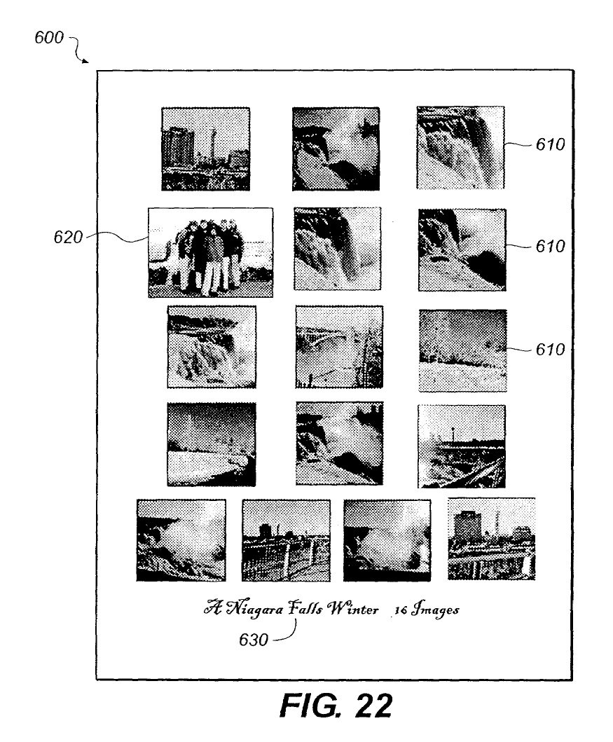

In block 418, the service provider creates a composite image product using the user's images in combination with those retrieved from the database. The retrieved content may correspond to the time of year, or the time of day, when the images were captured. For example, FIG. 22 is a photo collage 600 created by combining a user image 620 with custom content 610 and title 630. the Niagara Falls content retrieved when the transferred user image files were taken in the winter may include professional photos of Niagara Falls during the winter 610, showing the ice and snow formations. In fall, the retrieved content may include professional photos of Niagara Falls taken during the fall, showing fall foliage. Also, if the transferred user image files were taken at night, the retrieved content may include professional photos of Niagara Falls taken at night, showing the colorful lights illuminating the falls.

Blocks 420 trough 428 of FIG. 21 are the same as those described earlier in reference to blocks 420-428 of FIG. 19.

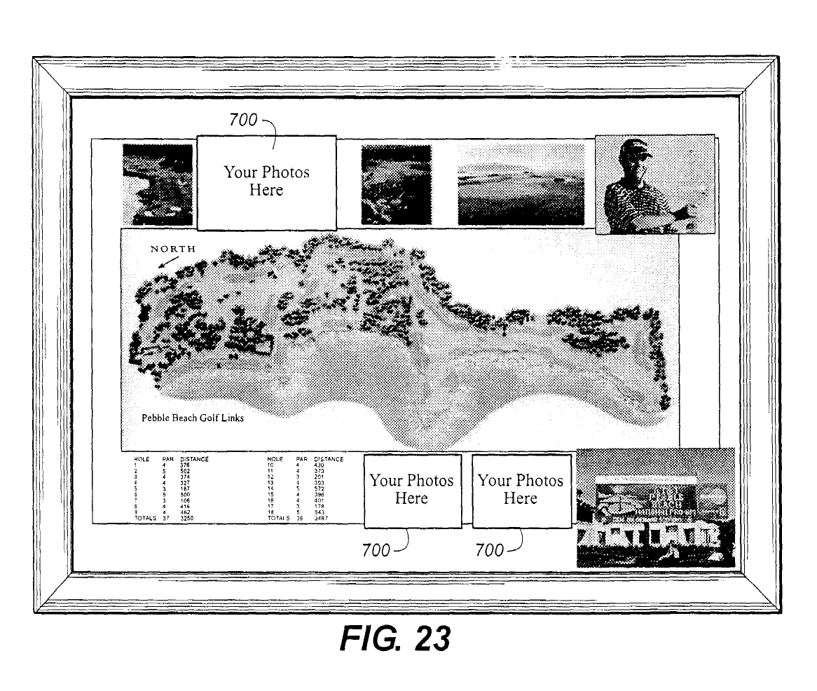

Referring back to FIG. 17, the system of FIG. 17 can be used in a different manner to provide enhanced photographic products. When camera phone 300A is in contact with service provider 280 via communication network 250 (FIG. 18) and cellular provider 240, the location of camera phone 300A can be transmitted to web server 282 and account manager 284. Account manager 284 accesses custom content database 240 to compare the time and current location of camera phone 300A to times and locations stored in custom content database 240. If there is a match or a near match between the time and location of camera phone 300A and any time and location in the custom content database, the user of camera phone can be alerted and prompted to capture images that can be used to create enhanced photographic products. Prompting can include providing an example of a photo product that may be produced, such as FIG. 23, indicating areas within the photo product where user images may be inserted 700. In this manner, service provider 280 can provide a more comprehensive service to the user of camera phone 300A by prompting the user to capture images for storage in customer database 288.

If camera phone 300A is in frequent contact with service provider 280 and is updating the its location on a regular basis, the alert and prompt can be sent from the service provider 280 to camera phone 300A at the time the camera approaches a location that corresponds to a time and location in custom content database 240. If camera phone 300A is not in frequent contact with service provider 280, service provider 280 may send a listing of times and locations to camera phone 300A that are potential destinations for camera phone 300A. Camera phone 300A stores the listing of times and locations. When an application running on camera phone 300A detects that it is at or near a location on the list at the appropriate time, it may alert and prompt the user.

The listing of locations may be modified by personal preference. The user may interact with service provider 280 to create a record of personal preferences corresponding to types of events that interest the user. This record of personal preferences can be used to screen custom content for the types of events that the service provider may use to create enhanced photographic products, or the types of alerts and prompts that are sent.

Additionally, personal preferences for events may be inferred from the time and location of phone camera 300A. If phone camera 300A is used to capture photos of an event or events having to do with auto racing, service provider 280 may create or add to a record of personal preferences corresponding to auto racing. This record of personal preferences can be used to screen custom content for future types of events for offers to the user. This record of personal preferences can also be used to make alerts and prompts corresponding to the user's interests.

The invention has been described with reference to a preferred embodiment. However, it will be appreciated that variations and modifications can be effected by a person of ordinary skill in the art without departing from the scope of the invention.

PARTS LIST

| | |
|---|---|
| 10 | capture subsystem |
| 12 | processing subsystem |
| 14 | database |
| 15 | product composer |
| 16 | digital processor |
| 17 | monitor |
| 18 | enhanced image products |
| 18a | print |
| 18b | album |
| 18c | CD or DVD |
| 18d | on-line products |
| 19 | fulfillment processor |
| 20a | attraction site |
| 20b | attraction site |
| 20c | attraction site |
| 21 | memory card |
| 22a | wireless communication station |
| 22b | wireless communication station |
| 22c | wireless communication station |
| 23 | record |
| 24a | digital camera |
| 24b | film camera |
| 26 | transceiver |
| 26 | antenna |
| 27 | location memory |
| 28 | lens section |
| 28a | field of view |
| 30 | transceiver section |
| 31 | user interface |
| 32 | infrared emitter |
| 34 | infrared detector |
| 36 | IrDA interface |
| 110 | film roll |
| 112 | memory card |
| 114 | short range RF transmitter |
| 116 | receiver |
| 118 | MEMS device |
| 120 | LCD information display |
| 122 | menu button |
| 124 | buttons |
| 126 | computer connector |
| 128 | dock connection |
| 130 | flexible sleeve |
| 132 | opening |
| 134 | single use camera |
| 136 | hole |
| 138 | hole |
| 140 | hole |
| 142 | hole |
| 144 | door |
| S100–S176 | steps |
| 200 | separate recording device |
| 202 | GPS receiver |
| 203 | antenna |
| 204 | clock |
| 206 | recorder |
| 208 | start button |
| 210 | memory card |
| 218 | PC |
| 220 | CSP Communication Services Provider |
| 222 | CSP |
| 224 | Kiosk Printer |
| 240 | Cellular Provider Network |
| 250 | Communication Network |
| 268 | Delivery Truck |
| 270 | Fulfillment Provider |
| 272 | Web Server |
| 274 | Commerce Manager |
| 275 | Fulfillment Manager |
| 276 | Fulfillment Manager |
| 278 | Digital Printer |
| 279 | DVD Writer |
| 280 | Service Provider |
| 282 | Web Server at Service Provider |
| 284 | Account Manager |
| 286 | Computer system |
| 288 | Customer Database |
| 300A | Phonecam at location A |
| 300B | Phonecam at location B |
| 300 | Phonecam |
| 302 | Flash |
| 304 | Lens |
| 310 | CMOS Sensor |
| 312 | Timing Generator |
| 314 | Image Sensor Array |
| 316 | A/D Converter |
| 318 | DRAM Buffer Memory |
| 320 | Digital Processor |
| 322 | RAM |
| 324 | Real Time Clock |
| 328 | Firmware Memory |
| 330 | Image/Data Memory |
| 332 | Color Display |
| 334 | User Controls |
| 340 | Audio Codec |
| 342 | Microphone |
| 344 | Speaker |
| 350 | Wireless Modem |
| 362 | Dock Interface |
| 364 | Dock Recharger |
| 500 | Framed Poster Print |
| 520 | Composite Image |
| 522 | User Image |
| 524 | Graphic Image |
| 526 | Title text |
| 530 | Custom Content at location |
| 532 | Custom Content at event |
| 600 | Collage |
| 610 | Custom Content taken during season |
| 620 | User Image during season |
| 630 | Title text |
| 700 | User image location |

What is claimed is:

1. A method for producing an enhanced photographic product, comprising:
storing custom content for a plurality of events in a custom content database;
receiving a digital image and information from a digital image capture device defining the time and geographic location the digital image was captured;
automatically determining if the time and the geographic information corresponds to one or more of the plurality of events stored in the custom content database; and
producing an enhanced photographic product including the received digital image and at least a portion of the custom content for one or more plurality of events in the custom content database corresponding to the digital image.

2. The method of claim 1, wherein receiving the digital image comprises receiving the digital image from a camera over a wireless network.

3. The method of claim 2 further comprising communicating a composite image to the camera over the wireless network.

4. The method of claim 3 further comprising receiving an order in relation to the enhanced photographic product from the camera over the wireless network.

5. The method of claim 1, wherein storing the custom content further comprises storing different images of the plurality of events.

6. The method of claim 1, wherein producing the enhanced photographic product further comprised producing composite print.

7. The method of claim 1 further comprising enabling a user to purchase the enhanced photographic product.

8. The method of claim 1, wherein producing the enhanced photographic product further comprises providing a plurality of received digital images.

9. The method of claim 8, wherein producing the enhanced photographic product further comprises producing a poster print.

10. The method of claim 8, wherein producing the enhanced photographic product further comprised producing a digital memory device.

11. The method of claim 1, wherein storing custom content further comprises storing a plurality of images.

12. The method of claim 1, wherein producing the enhanced photographic product further comprises producing an enhanced photographic product only when the event conforms to user preferences.

13. The method of claim 12 further comprising entering the user preferences into the system by the user.

14. A method for producing an enhanced photographic product, comprising:
storing custom content for a plurality of events in a custom content database;
receiving a digital image and information from a digital image capture device defining the time and geographic location the digital image was captured;
automatically determining if the time and the geographic information corresponds to one or more of the plurality of events stored in the custom content database; and
producing an enhanced photographic product including the received digital image and at least a portion of the custom content for one or more plurality of events in the custom content database corresponding to the digital image only when the event conforms to user preferences, wherein the user preferences is determined by analyzing the photographic behavior of the user by the system.

15. A method for producing an enhanced photographic product, comprising:
storing custom content for a plurality of events in a custom content database;
automatically determining if user time and geographic information corresponds to one of the plurality of events in the custom content database;
prompting the user to capture images when the user geographic information corresponds to at least one of the plurality of events;
capturing a digital image using a digital device of the user and receiving geographic information and user time defining the location of the user and the time when the digital image was captured; and
producing an enhanced photographic product comprising the received digital image and at least a portion of the custom content.

16. The method of claim 15, wherein capturing the digital image further comprises capturing the digital image from a camera over a wireless network.

17. The method of claim 16 further comprising communicating a composite image to the camera over the wireless network.

18. The method of claim 17 further comprising receiving an order in relation to the enhanced photographic product from the camera over the wireless network.

19. The method of claim 15, wherein storing the custom content further comprises storing a different images of the plurality of events.

20. The method of claim 15, wherein producing the enhanced photographic product further comprised producing a composite print.

21. The method of claim 15 further comprising enabling a user to purchase the enhanced photographic product.

22. The method of claim 15, wherein producing the enhanced photographic product further comprises providing a plurality of received digital images.

23. The method of claim 15, wherein producing the enhanced photographic product further comprises producing a poster print.

24. The method of claim 15, wherein producing the enhanced photographic product further comprised producing a digital memory device.

25. The method of claim 15, wherein producing the enhanced photographic product further comprises producing an enhanced photographic product produced only when the event conforms to user preferences.

26. The method of claim 25 further comprising entering the user preferences into the system by the user.

27. The method of claim 25 further comprising analyzing the photographic behavior of the user by the system and determining user preferences by the system.

28. The method of claim 15, wherein storing custom content further comprises storing a plurality of images.

29. A system for producing an enhanced photographic product, comprising:
a database for storing custom content for a plurality of events;
a digital image capture device for receiving a digital image and information defining the time and geographic location the digital image was captured and automatically determining if the time and the geographic information corresponds to one or more of the plurality of events stored in the database; and
a processor for producing an enhanced photographic product including the received digital image and at least a portion of the custom content corresponding to the digital image for the one or more plurality of events found in the database.

30. The system of claim 29, wherein the digital image capture device is a digital camera for receiving the digital image over a wireless network.

31. The system of claim 30, wherein the digital image is a composite image.

32. The system of claim 29, wherein the custom content includes different images of the plurality of events.

33. The system of claim 29, wherein the enhanced photographic product is a composite print.

34. The system of claim 29, wherein the enhanced photographic product includes a plurality of received digital images.

35. The system of claim 29, wherein the enhanced photographic product further comprises a poster print.

36. The system of claim 29, wherein the enhanced photographic product further comprised a digital memory device.

37. The system of claim 29, wherein the enhanced photographic product is produced only when the event conforms to user preferences.

38. The system of claim 37, wherein the user preferences are entered into the system by the user.

39. The system of claim 37, wherein the photographic behavior of the user and the user preferences are analyzed by the system.

40. The system of claim 29, wherein the custom content further comprises a plurality of images.
